(19) United States
(12) Patent Application Publication
(10) Pub. No.: US 2026/0030772 A1
(43) Pub. Date: Jan. 29, 2026

(54) SYSTEMS AND METHODS FOR BOX DIMENSIONING

(71) Applicant: Hand Held Products, Inc., Charlotte, NC (US)

(72) Inventors: Javier GONZALEZ, Charlotte, NC (US); Jean Luc COURTEMANCHE, Charlotte, NC (US); Sudhindra Dattatreya MEWUNDI, Charlotte, NC (US); Arjun MURTHY, Charlotte, NC (US); Weihua J. GUAN, Charlotte, NC (US); Hussian Ali AL-AMRI, Charlotte, NC (US); Daniel James YEE, Charlotte, NC (US); Hui-Ching YU, Charlotte, NC (US); Lori C. HAGGART, Charlotte, NC (US); Vijay DESHPANDE, Charlotte, NC (US); Vasudevakrishna JOSHI, Charlotte, NC (US); Dileep BOORAVILLI, Charlotte, NC (US); Jasper LI, Charlotte, NC (US)

(21) Appl. No.: 19/265,307

(22) Filed: Jul. 10, 2025

(30) Foreign Application Priority Data
Jul. 24, 2024 (CN) 202410996389.3

(51) Int. Cl. G06T 7/62; G06T 7/13; G06V 10/28; G06V 10/44

(52) U.S. Cl. CPC G06T 7/62; G06T 7/13; G06V 10/28; G06V 10/454

(57) ABSTRACT

A system and method for box dimensioning are disclosed. The system comprises a scanner to capture images of at least one object with at least one image capturing device and create one or more coloured map images for obtaining pixel information. Further, one or more sensors are configured to determine depth and distance information of each pixel of one or more coloured map images. Further, the system comprises at least one system processor to determine a plurality of pixel coordinates of each corner of a plurality of corners of at least one object based at least on distance information, determine a plurality of corner points of each corner based at least on plurality of pixel coordinates, map each corner point of plurality of corner points to a respective predefined distance, and determine a plurality of dimensions of at least one object based at least on mapping and determined depth information.

### CROSS-REFERENCE TO RELATED APPLICATIONS

This application claims priority pursuant to 35 U.S.C. 119(a) to Chinese Application No. 202410996389.3, filed Jul. 24, 2025, which application is incorporated herein by reference in its entirety.

### TECHNOLOGICAL FIELD

The present disclosure generally relates to dimensioning technology and automation, and more specifically, relates to systems and method for box dimensioning.

### BACKGROUND

In the dynamic landscape of parcel transportation, warehouse management, and logistics, accurate box dimensioning estimation is an important element, enabling efficient space planning and resource allocation. Conventional dimensioning systems such as Light Detection and Ranging (LIDAR), structure of light, and time of flight (TOF), offer valuable capabilities. However, the conventional dimensioning systems fall short in achieving compact integration and hinder widespread adoption. Further, conventional methods of the dimensioning systems addressing irregularly shaped objects entail costly setups, such as specialized laser units and rotating stands, that further complicate the conventional methods. Moreover, the lack of integration between barcode scanning and conventional dimensioning methods necessitates the use of separate systems for dimensioning and for barcode scanning, which adds complexity and cost inefficiency.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a system for box dimensioning is disclosed. The system comprises a scanner. The scanner is configured to capture one or more images of at least one object with at least one image capturing device and create one or more coloured map images of the at least one object based on the one or more images for obtaining pixel information. Further, one or more sensors are operationally coupled with the at least one image capturing device. The one or more sensors are configured to determine a depth information and a distance information of each pixel of the one or more coloured map images, based at least on the pixel information. The system further comprises at least one system processor operationally coupled with the scanner and at least one memory storing instructions that when executed by the at least one system processor cause the system to determine, for at least one of the one or more coloured map images, a plurality of pixel coordinates of each corner of a plurality of corners of the at least one object based at least on the distance information of each pixel; determine, for at least one of the one or more coloured map images, a plurality of corner points of each corner of the plurality of corners of the at least one object based at least on the plurality of pixel coordinates; map, for at least one of the one or more coloured map images, each corner point of the plurality of corner points to a respective predefined distance of the at least one object; and determine a plurality of dimensions of the at least one object based at least on the mapping of each corner point to the respective predefined distance and the determined depth information.

In some embodiments, the at least one system processor is further configured to mask the one or more coloured map images and determine the distance information of each pixel from a focal plane based at least on the masked one or more colored images.

In some embodiments, the at least one memory storing instructions, when executed by the at least one system processor, further cause the system to map the determined plurality of corner points to the respective predefined distance of the at least one object using a sparse depth map. In some embodiment, the plurality of corner points comprises at least one of length coordinates, breadth coordinates, and height coordinates.

In some embodiments, the at least one memory storing instructions, when executed by the at least one system processor, further cause the system to convert the one or more coloured map images into one or more grey scale images and decode one or more values of one or more one-dimensional barcodes or one or more two-dimensional barcodes associated with the at least one object based on the one or more grey scale images. The at least one memory storing instructions, when executed by the at least one system processor, further cause the system to aggregate the one or more values decoded of the one or more one-dimensional barcodes and the one or more two-dimensional barcodes and the plurality of dimensions of the at least one object and display the one or more values aggregated on a display device.

In some embodiments, the at least one memory storing instructions, when executed by the at least one system processor, further cause the system to determine the plurality of corners by using the depth information received from the one or more sensors or using deep learning protocols. Further, the deep learning protocols correspond to a convolutional neural network (CNN) based corner detection technique that takes the one or more coloured map images as an input and outputs a region that corresponds to the plurality of corners.

In some embodiments, the at least one memory storing instructions, when executed by the at least one system processor, further cause the system to perform image segmentation on the one or more images to determine a plurality of edges from the plurality of corners. The image segmentation is performed by drawing a plurality of imaginary lines over the one or more images to connect each corner of the plurality of corners, discarding one or more intersecting imaginary lines from the plurality of imaginary lines, and connecting the plurality of corners in an anticlockwise direction or in a clockwise direction to determine the plurality of edges.

In some embodiments, the one or more sensors comprises at least a CMOS sensor. The CMOS sensor comprises at least one integrated circuit configured to determine the depth information by using object dimensioning of a three-dimensional image.

In some embodiments, a tunable lens is communicatively coupled to the at least one image capturing device. The tunable lens is configured to fine-tune a plurality of parameters of the image capturing device. In some embodiments, the plurality of parameters comprises at least one of exposure, analog gain, and/or confidence threshold and a plurality of corrective measures. The plurality of corrective measures comprises lightning conditions, background contrast, reduce reflection, and repositioning of the at least one image capturing device.

In another example embodiment, a method is disclosed. The method comprises capturing one or more images of at least one object with at least one image capturing device of a scanner. Further, the method comprises creating one or more coloured map images of the at least one object based on the one or more images for obtaining pixel information. Further, the method comprises determining, with one or more sensors operationally coupled with the at least one image capturing device, a depth information and a distance information of each pixel of the one or more coloured map images, based at least on the pixel information. Further, the method comprises determining, for at least one of the one or more coloured map images, a plurality of pixel coordinates of each corner of a plurality of corners of the at least one object based at least on the distance information of each pixel. Further, the method comprises determining, for at least one of the one or more coloured map images, a plurality of corner points of each corner of the plurality of corners of the at least one object based at least on the plurality of pixel coordinates. Further, the method comprises mapping, for at least one of the one or more coloured map images, each corner point of the plurality of corner points to a respective predefined distance of the at least one object. Thereafter, the method comprises determining a plurality of dimensions of the at least one object based at least on the mapping of each corner point to the respective predefined distance and the determined depth information.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a system for box dimensioning in accordance with an example embodiment of the present disclosure;

FIG. 2 illustrates a flowchart showing a combined method for decoding one or more values of one or more one-dimensional barcodes, one or more two-dimensional barcodes, and a plurality of dimensions of at least one object in accordance with an example embodiment of the present disclosure;

FIG. 3 illustrates a flowchart showing a method for decoding one or more values of the one or more one-dimensional barcodes and the one or more two-dimensional barcodes of the at least one object in accordance with an example embodiment of the present disclosure;

FIG. 4 illustrates a flowchart showing a method for decoding one or more values of the plurality of dimensions of at least one object in accordance with an example embodiment of the present disclosure;

FIG. 5A illustrates a flowchart showing a method for box dimensioning in accordance with an example embodiment of the present disclosure;

FIG. 5B illustrates the captured one or more images in accordance with an example embodiment of the present disclosure;

FIG. 5C illustrates a flowchart showing a method for box dimensioning of a regular shaped object in accordance with an example embodiment of the present disclosure;

FIG. 5D illustrates a flowchart showing a method for box dimensioning of an irregular shaped object in accordance with an example embodiment of the present disclosure;

FIG. 6 illustrates at least one object having a plurality of corner points in accordance with an example embodiment of the present disclosure;

FIG. 7 illustrates a plurality of objects similar to at least one object having the plurality of corners in accordance with an example embodiment of the present disclosure;

FIG. 8 illustrates a flowchart showing a method to detect a plurality of edges of the at least one object in accordance with an example embodiment of the present disclosure;

FIG. 9 illustrates the at least one object having a plurality of imaginary lines connecting all the plurality of corner points in accordance with an example embodiment of the present disclosure;

FIG. 10 illustrates the at least one object having an outer boundary in accordance with an example embodiment of the present disclosure;

FIG. 11A illustrates the at least one object selecting at least one of the plurality of corner points from the formed outer boundary to traverse in a clockwise direction to connect with the at least next three corner points from the plurality of corner points in accordance with an example embodiment of the present disclosure;

FIG. 11B illustrates the at least one object selecting at least one of the plurality of corner points from the formed outer boundary to traverse in an anticlockwise direction to connect with the at least next three corner points from the plurality of corner points in accordance with an example embodiment of the present disclosure;

FIG. 12 illustrates a plurality of edges selected in the at least one object in accordance with an example embodiment of the present disclosure;

FIG. 13A illustrates a flowchart of a method of a dimensioning architecture of the system in accordance with an example embodiment of the present disclosure;

FIG. 13B illustrates a dimension network of the dimensioning architecture in accordance with an example embodiment of the present disclosure;

FIG. 13C illustrates an exemplar scenario of the dimensioning architecture in accordance with an example embodiment of the present disclosure;

FIG. 14A illustrates a left limit and a right limit in the one or more images of the at least one object in accordance with an example embodiment of the present disclosure;

FIG. 14B illustrates one or more top values of the left limit and the right limit of the at least one object in accordance with an example embodiment of the present disclosure;

FIG. 14C illustrates one or more bottom values of the left limit and the right limit of the at least one object in accordance with an example embodiment of the present disclosure;

FIG. 15A illustrates determination of a real-world length of the at least one object in accordance with an example embodiment of the present disclosure;

FIG. 15B illustrates determination of a real-world height of the at least one object in accordance with an example embodiment of the present disclosure;

FIG. 15C illustrates determination of a real-world width of the at least one object in accordance with an example embodiment of the present disclosure;

FIG. 16 illustrates a scanner of the system in accordance with an example embodiment of the present disclosure;

FIG. 17A illustrates a tunable lens with a variable stop size in accordance with an example embodiment of the present disclosure;

FIG. 17B illustrates the tunable lens with a variable focal length in accordance with an example embodiment of the present disclosure;

FIG. 18 illustrates a user interface (UI) of a feedback for taking a plurality of corrective measures in accordance with an example embodiment of the present disclosure;

FIG. 19A illustrates one or more underexposed images of the at least one object with missing depth information in accordance with an example embodiment of the present disclosure;

FIG. 19B illustrates properly formed edges from the plurality of edges and properly formed corners from the plurality of corners of the at least one object in accordance with an example embodiment of the present disclosure;

FIG. 19C illustrates one or more underexposed images of another at least one object with missing depth information in accordance with an example embodiment of the present disclosure;

FIG. 19D illustrates the one or more properly formed edges and the one or more properly formed corners of the another at least one object in accordance with an example embodiment of the present disclosure;

FIG. 20 illustrates a simulation result showing determination of a plurality of dimensions of at least one object in accordance with an example embodiment of the present disclosure;

FIG. 21 illustrates another simulation result showing determination of a plurality of dimensions of at least one object in accordance with an example embodiment of the present disclosure;

FIG. 22 illustrates another simulation result showing determination of a plurality of dimensions of at least one object in accordance with an example embodiment of the present disclosure; and,

FIG. 23 illustrates a flowchart showing a method for the system for box dimensioning in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of systems and methods to utilize five-dimensional (5D) technology for combined two-dimensional (2D) imaging and three-dimensional (3D) dimensioning of at least one object. Embodiments may be configured to capture one or more images of the at least one object. Embodiments may be configured to create one or more coloured map images of the one or more images to obtain pixel information of the at least one object. Embodiments may be configured to convert the one or more images to one or more grey scale images. Embodiments may be configured to perform a plurality of metric measurements on the one or more grey scale images using the obtained pixel information. Embodiments may be configured to detect depth information of the at least one object based at least on the performed metric measurements. Embodiments may be configured to analyse the generated depth information to generate a plurality of representations and measurements of the at least one object. Embodiments may be configured to interpret the plurality of representations and measurements to perform 2D scanning and 3D dimensioning of the at least one object. Embodiments may be configured to provide with information on the at least one object volume, dimensions, and decoded barcode value of the at least one object.

In some embodiments, the system leverages the 5D technology to seamlessly integrate the 2D imaging and the 3D dimensioning capabilities within the single system. The process of the 2D imaging and the 3D dimensioning involves several steps such as, combining the one or more images capture, barcode decoding, depth estimation, dimension calculation, and calibration to provide the comprehensive information about the one or more scanned objects, typically a box. Through parallel processing, the depth estimation, the at least one object dimensioning algorithms, and the calibration, the system provides accurate and the comprehensive information about the one or more scanned objects. The final output of the 2D imaging and the 3D dimensioning includes details such as the at least one object volume, the at least one object dimensions, and the decoded barcode values, offering a versatile solution for various applications requiring both the 2D imaging and the 3D dimensional data. The process of the 2D imaging and the 3D dimensioning using the system initiates by capturing the one or more images of the at least one object, such as the box, which includes the one or more 2D images like the barcode.

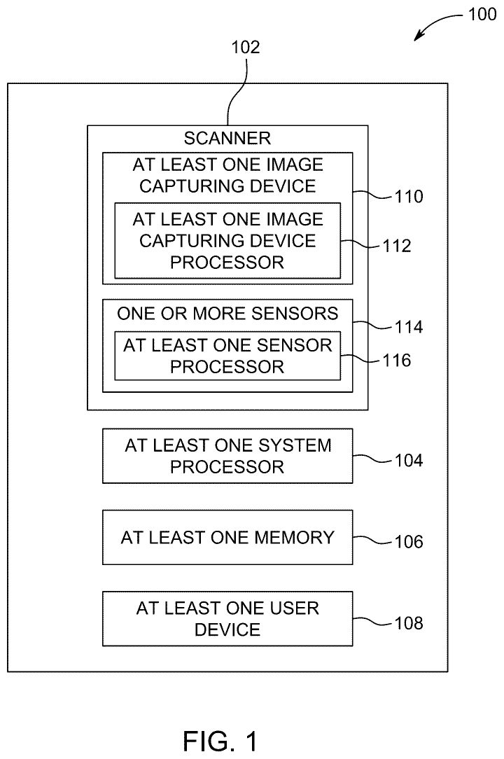

FIG. 1 illustrates a block diagram of a system 100 for box dimensioning, in accordance with an example embodiment of the present disclosure. The system 100 may comprise a scanner 102, at least one system processor 104, at least one memory 106, and at least one user device 108.

In some embodiments, the scanner 102 may comprise at least one image capturing device 110 having at least one image capturing device processor 112. In some embodiments, the at least one image capturing device 110 using the at least one image capturing device processor 112, may be configured to capture one or more images of at least one object (not shown). In some embodiments, the at least one image capturing device 110 using the at least one image capturing device processor 112, may be configured to capture a visual information in the form of the one or more images. The visual information may refer to data obtained through capturing of the one or more images. The visual information may comprise at least one object present in the one or more images. So, in this case, the visual information may be the one or more images that convey details about the at least one object. comprise The primary function of the at least one image capturing device 110, using the at least one image capturing device processor 112, may be configured to capture the one or more images of the at least one object placed in a field of view (FOV) of the at least one image capturing device 110. The at least one image capturing device 110 may capture one or more images of the at least one object by focusing on relevant features such as one-dimensional barcode or a two-dimensional barcode. Further, the at least one image capturing device 110 may capture the one or more images in the red, green, and blue (RGB) spectrum. In an alternate embodiment, the at the at least one image capturing device 110 may be configured to capture one or more images of at least one object using the at least one system processor 104.

Further, the at least one image capturing device 110, using the at least one image capturing device processor 112, may be configured to create one or more coloured map images of the at least one object. The one or more coloured map images may be created based on the one or more images. The at least one image capturing device 110 using the at least one image capturing device processor 112, may be configured to create one or more coloured map images for obtaining pixel information of the at least one object. In some embodiments, the at least one image capturing device processor 112 may be provided with one or more instructions to manipulate and enhance the one or more images. The at least one image capturing device processor 112 may apply one or more algorithms and techniques to alter or analyse the one or more images for various purposes, including improving visual quality, extracting the information, or enabling computer vision capabilities.

The at least one image capturing device 110 may operate on a principle of capturing light and converting the light into the one or more images through the at least one image capturing device processor 112. In some embodiments, basic components of the at least one image capturing device 110 may include a lens, a shutter, an aperture, the image sensor, a screen, the at least one image capturing device processor 112, a memory, and a flash. In some embodiments, examples of the at least one image capturing device 110 may comprise at least one of point-and-shoot cameras, Digital Single-Lens Reflex (DSLRs), mirrorless cameras, and any other image capturing device known in the art, each designed specifically for a user needs and preferences.

Further, the scanner 102 may comprise one or more sensors 114 having at least one sensor processor 116. The one or more sensors 114 may be operationally coupled with the at least one image capturing device 110. In some embodiments, the one or more sensors 114 using the at least one sensor processor 116, may be configured to determine a depth information of each pixel of the one or more coloured map images. Further, the one or more sensors 114 using the at least one sensor processor 116, may be configured to determine a distance information of each pixel of the one or more coloured map images. The one or more sensors 114 may be configured to determine the depth information and the distance information based at least on the pixel information. In some embodiments, the one or more sensors 114 using the at least one sensor processor 116, may be configured to detect and measure physical properties or changes in the environment and convert the detected information into signals or the data that can be interpreted, displayed, or used to control the system 100. In some embodiments, the one or more sensors 114 using the at least one sensor processor 116, may be configured to capture various aspects of the at least one object being analysed, contributing to both the 2D imaging and the 3D dimensioning processes.

In some embodiments, the one or more sensors 114 using the at least one sensor processor 116, may be configured to detect specific physical phenomena or properties, such as temperature, pressure, light, sound, motion, proximity, humidity, or chemical composition. In an alternate embodiment, the one or more sensors 114 may determine the depth information using at least one system processor 104. In one example, the one or more sensors 114 may utilize a transducer to convert the determined depth information and the distance information into an electrical signal. The conversion may allow for easier processing and communication of the determined depth information and the distance information. The electrical signal as an output signal from the one or more sensors 114 may take one or more forms, including electrical voltage, current, resistance, frequency, or digital data, depending on type of the one or more sensors 114.

In some embodiments, the one or more sensors 114 may be characterized by the accuracy that reflects how closely the measured value of the determined depth information and the distance information corresponds to the actual value of the depth information and the distance information, and precision that measures the repeatability of the readings of the one or more sensors 114. In one example, the one or more sensors 114 may comprise at least a Complementary metal-oxide semiconductor (CMOS) sensor comprising at least one integrated circuit configured to determine the depth information by using object dimensioning of a three-dimensional image. Object dimensioning may correspond to the spatial dimensions of objects within the three-dimensional image. Through the analysis of captured images, these sensors leverage advanced algorithms to precisely measure distances between various points in the scene, enabling the determination of length, width, and height of objects. In another example, the one or more sensors 114 may comprise at least one of temperature sensors, pressure sensors, motion sensors, light sensors, proximity sensors, and other sensors known in the art designed for determining the depth information and the distance information.

In another embodiment, the at least one image capturing device 110 may be configured to capture and store the one or more images, either digitally, via the one or more sensors 114, or chemically, via a light-sensitive material such as photographic film installed within the at least one image capturing device 110. Further, the one or more sensors 114 may include an image sensor. The image sensor may convert light into digital data for capturing the one or more images and storage of the captured. Further, the at least one image capturing device 110 may capture and record visual information of the at least one object, through the one or more sensors 114.

In some embodiments, the system 100 may comprise the at least one system processor 104. The at least one system processor 104 may be operationally coupled with the scanner 102 and the at least one memory 106. Further, the at least one memory 106 storing instructions that when executed by the at least one system processor may cause the system 100 to determine, for at least one of the one or more coloured map images, a plurality of pixel coordinates of each corner of a plurality of corners of the at least one object. The at least one system processor 104 may be configured to determine the plurality of pixel coordinates based at least on the distance information of each pixel. The at least one system processor 104 may be configured to determine the plurality of corners by using the depth information received from the one or more sensors 114 or using deep learning protocols. The deep learning protocols may correspond to a convolutional neural network (CNN) based corner detection technique that takes the one or more coloured map images as an input and outputs a region that corresponds to the plurality of corners. Further, the at least one system processor 104 may be configured to determine, for at least one of the one or more coloured map images, a plurality of corner points of each corner of the plurality of corners of the at least one object based at least on the plurality of pixel coordinates. The plurality of corner points may comprise at least one of length coordinates, breadth coordinates, and height coordinates.

Further, the at least one system processor 104 may, for at least one of the one or more coloured map images, each corner point of the plurality of corner points to a respective predefined distance of the at least one object. The at least one system processor 104 may be configured to map the determined plurality of corner points to the respective predefined distance of the at least one object using a sparse depth map. The sparse depth map may refer to a representation of the mapped plurality of corner points to the respective predefined distance. The sparse depth map may focus on key reference points, such as the plurality of corner points, and map to respective predefined distance. Thereafter, the at least one system processor 104 may determine a plurality of dimensions of the at least one object. The at least one system processor 104 may determine the plurality of dimensions based at least on the mapping of each corner point and the determined depth information. In one example, the plurality of dimensions may correspond to length, breadth, and height of the at least one object.

In some embodiments, the at least one system processor 104 may include suitable logic, circuitry, and/or interfaces that are operable to execute one or more instructions stored in the at least one memory 106 to perform predetermined operations. In one embodiment, the at least one system processor 104 may comprise the at least one memory 106 storing one or more instructions that when executed by the at least one system processor 104 may cause the at least one system processor 104 to perform the one or mor instructions. In another embodiment, the at least one system processor 104 may be configured to decode and execute any instructions received from one or more other electronic devices or server(s). The at least one system processor 104 may be configured to execute one or more computer-readable program instructions, such as program instructions to carry out any of the functions described in this description. Further, the processor may be implemented using one or more processor technologies known in the art. Examples of the processor include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

Further, the at least one memory 106 may be communicatively coupled to the at least one system processor 104. Further, the at least one memory 106 may be configured to store a set of instructions and data executed by the at least one system processor 104. Further, the at least one memory 106 may include the one or more instructions that are executable by the at least one system processor 104 to perform specific operations. The at least one memory 106 may include one or more instructions to determine, for at least one of the one or more coloured map images, the plurality of pixel coordinates of each corner of the plurality of corners of the at least one object based at least on the distance information of each pixel. The at least one memory 106 may include one or more instructions to determine, for at least one of the one or more coloured map images, the plurality of corner points of each corner of the plurality of corners of the at least one object based at least on the determined plurality of pixel coordinates. The at least one memory 106 may include one or more instructions to map, for at least one of the one or more coloured map images, each corner point of the plurality of corner points to the respective predefined distance of the at least one object.

The at least one memory 106 may include one or more instructions to determine the plurality of dimensions of the at least one object based at least on the mapping and the determined depth information. It is apparent to a skilled artisan that the one or more instructions stored in the at least one memory 106 enable the hardware of the system to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The system 100 may further include the at least one user device 108 that may be configured to receive 2D imaging output and the 3D measurements or 3D dimensions of the at least one object. The 2D imaging output may comprise decoded value of the one or more one-dimensional barcodes and one or more two-dimensional barcodes of the at least one object. The 3D measurements or 3D dimensions may comprise decoded value of the plurality of dimensions of the at least one object. The at least one user device 108 may be wired, or wirelessly coupled to the at least one system processor 104. In alternate embodiments, the at least one user device 108 may be separate and remote from the system 100 and in communication with the system 100. In some embodiments, the at least one user device 108 may include one or more wired or wireless devices operationally coupled to the system 100, including, a desktop or laptop computer, a tablet, a smart phone, or other handheld computing device known in the art.

Further, the system 100 may include an input/output circuitry (not shown) that may enable the one or more users to communicate or interface with the system 100 via the at least one user device 108. The at least one user device 108 may include N number of user devices (not shown). In some example embodiments, the at least one user device 108 may include a control room computer system or other portable electronic devices. It may be noted that the input/output circuitry may act as a medium transmit input from the at least one user device 108 to and from the system 100. In some embodiments, the input/output circuitry may refer to the hardware and software components that facilitate the exchange of information between the one or more users and the system 100. The input/output circuitry may include various input devices such as keyboards, barcode scanners, GUI for the user to provide data and various output devices such as displays, printers for the user to receive data. In another example, the input/output circuitry may include various output circuitry such as indicators to indicate the correct and incorrect measurement or placement of the at least one object. In one example, the system 100 may include a graphical user interface (GUI) (not shown) that may be installed in the at least one user device 108 as input circuitry to allow the user to input data via the at least one user device 108.

In some embodiments, the system 100 may include a communication circuitry (not shown). The communication circuitry may allow the system 100 to exchange data or information with other systems. Further, the communication circuitry may include network interfaces, protocols, and software modules responsible for sending and receiving data or information. In some embodiments, the communication circuitry may include Ethernet ports, Wi-Fi adapters, or communication protocols like HTTP or MQTT for connecting with other systems. The communication circuitry may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry may allow the system to stay up-to-date and accurately determine the value of the one or more one-dimensional barcodes, one or more two-dimensional barcodes and the plurality of dimensions of the at least one object.

It will be apparent to one skilled in the art the above-mentioned components of the system 100 have been provided only for illustration purposes, without departing from the scope of the disclosure.

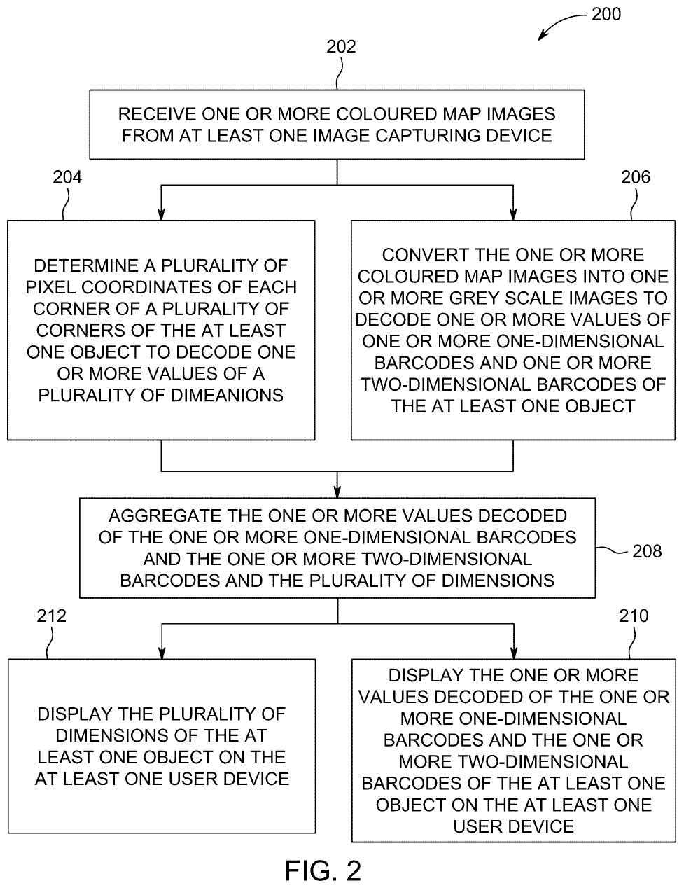

FIG. 2 illustrates a flowchart showing a combined method 200 for decoding one or more values of one or more one-dimensional barcodes, one or more two-dimensional barcodes, and a plurality of dimensions of at least one object, in accordance with an example embodiment of the present disclosure.

At operation 202, the at least one system processor 104 may be configured to receive the one or more colored map images from the at least one image capturing device 110. Further, the at least one system processor 104 may be configured to mask the one or more coloured map images. Further, the at least one system processor 104 may be configured to mask the one or more coloured map images using a specialised mask (SM). The SM may be configured to estimate both the depth information and the distance information on the masked one or more coloured images. The SM may be facilitated by a Time of Flight (TOF) or a stereo camera or structured light camera sensor. The at least one system processor 104 may be configured to determine the distance information of each pixel from a focal plane based at least on the masked one or more coloured images.

At operation 204, the at least one system processor 104 may be configured to determine the plurality of pixel coordinates of each corner of the plurality of corners of the at least one object to decode one or more values of the plurality of dimensions. The at least one system processor 104 may be configured to determine the plurality of pixel coordinates based at least on the distance information of each pixel. The at least one system processor 104 may be configured to detect the plurality of corners by using the depth information received from the one or more sensors 114 or using deep learning protocols.

Simultaneous to the operation 204, at operation 206, the at least one system processor 104 may be configured to convert the one or more coloured map images into one or more grey scale images to decode one or more values of one or more one-dimensional barcodes and one or more two-dimensional barcodes of the at least one object in the one or more grey scale images. At operation 208, the at least one system processor 104 may be configured to aggregate the one or more values decoded of the one or more one-dimensional barcodes and the one or more two-dimensional barcodes and the plurality of dimensions. At operation 210, the at least one system processor 104 may be configured to display the one or more values decoded of the one or more one-dimensional barcodes and one or more two-dimensional barcodes of the at least one object on the at least one user device 108.

Referring to FIG. 1, the at least one system processor 104 may be configured to determine the plurality of corner points of each corner of the plurality of corners of the at least one object based at least on the determined plurality of pixel coordinates. The plurality of corner points may comprise at least one of length coordinates, breadth coordinates, and height coordinates. Furthermore, the at least one system processor 104 may map each corner point from the plurality of corner points to the respective predefined distance of the at least one object. Thereafter, the at least one system processor 104 may determine the plurality of dimensions of the at least one object based at least on the mapping and the determined depth information. In some embodiments, the at least one system processor 104 may be configured to aggregate the decoded value of the one or more one-dimensional barcodes and one or more two-dimensional barcodes and the plurality of dimensions of the at least one object.

At operation 212, the at least one system processor 104 may be configured to display the plurality of dimensions of the at least one object on the at least one user device 108. In one example embodiment, the at least one system processor 104 may be configured to aggregate the decoded value of the one or more one-dimensional barcodes and one or more two-dimensional barcodes and the plurality of dimensions of the at least one object, for displaying on a display device of a user.

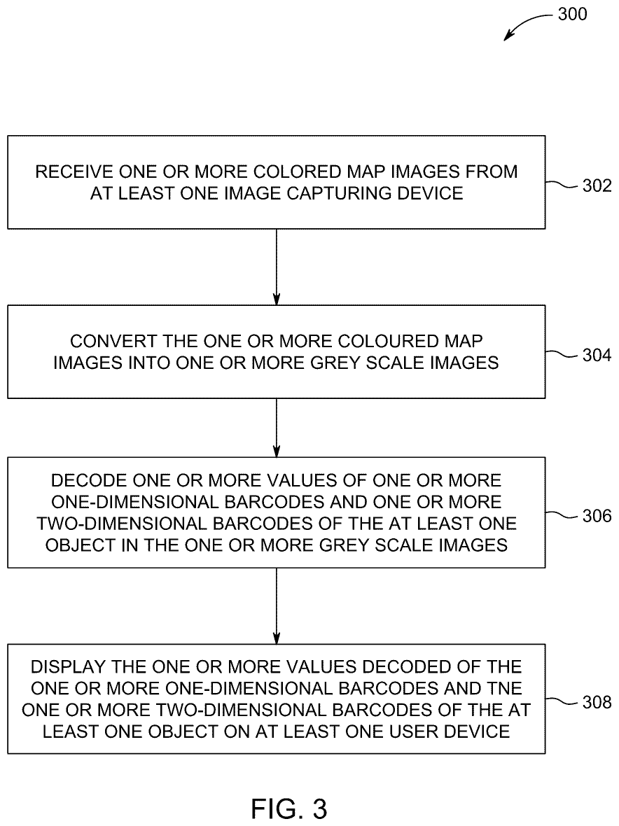

FIG. 3 illustrates a flowchart showing a method 300 for decoding one or more values of the one or more one-dimensional barcodes and the one or more two-dimensional barcodes of at least one object, in accordance with an example embodiment of the present disclosure.

At operation 302, the at least one system processor 104 may be configured to receive the one or more colored map images from the at least one image capturing device 110. Further, the at least one system processor 104 may be configured to mask the one or more coloured map images. The at least one system processor 104 may be configured to determine the distance of each pixel from a focal plane based at least on the masked one or more coloured images.

At operation 304, the at least one system processor 104 may be configured to convert the one or more coloured map images into one or more grey scale images. In some embodiments, the at least one system processor 104 may comprise a host-decoder image processing module that converts the one or more coloured map images into one or more grey scale images. Further, the one or more grey scale images may be fed into a decoder (not shown), where both the one-dimensional barcode and two-dimensional barcode decoding techniques is applied.

At operation 306, the at least one system processor 104 may be configured to decode one or more values of the one or more one-dimensional barcodes and the one or more two-dimensional barcodes of the at least one object in the one or more grey scale images. The decoded value may ensure the extraction of meaningful information from the one or more one-dimensional barcodes and one or more two-dimensional barcodes present on the at least one object, contributing to a comprehensive understanding of identity and attributes associated with the at least one object. At operation 308, the at least one system processor 104 may be configured to display the one or more values decoded of the one or more one-dimensional barcodes and the one or more two-dimensional barcodes of the at least one object on the at least one user device 108.

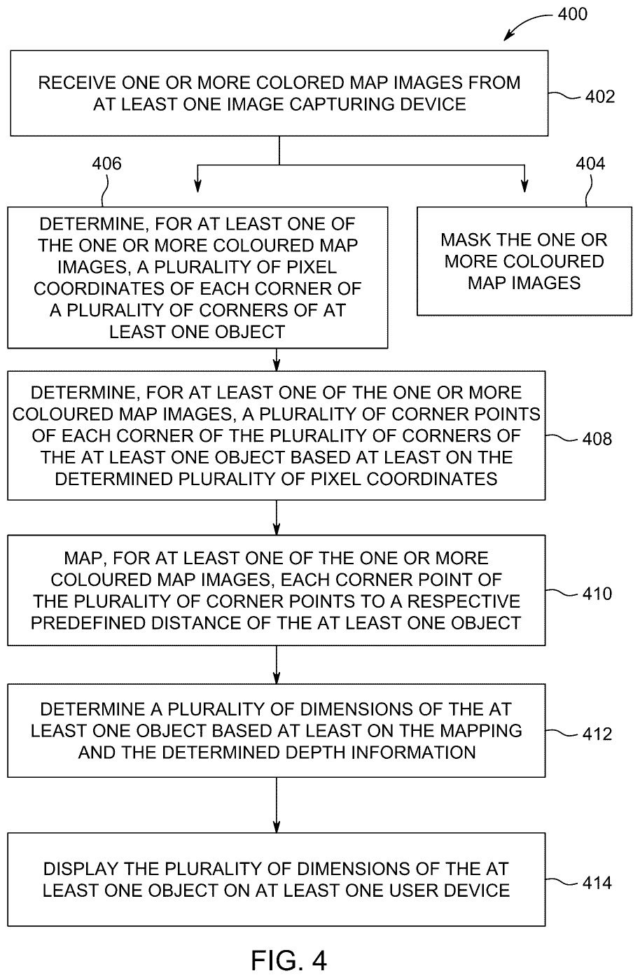

FIG. 4 illustrates a flowchart showing a method 400 for decoding one or more values of the plurality of dimensions of at least one object, in accordance with an example embodiment of the present disclosure.

At operation 402, the at least one system processor 104 may be configured to receive the one or more colored map images from the at least one image capturing device 110. At operation 404, the at least one system processor 104 may be configured too mask the one or more coloured map images. The at least one system processor 104 may be configured to mask the one or more coloured map images using a third-party library in the SM. In some embodiments, the third-party library may comprise a set of instructions to estimate a depth map. The depth map may be estimated using the TOF or a stereo vision sensor. The at least one system processor 104 may be configured to determine the distance of each pixel from a focal plane based at least on the masked one or more coloured images.

Simultaneous to operation 404, at operation 406, the at least one system processor 104 may be configured to determine, for at least one of the one or more coloured map images, the plurality of pixel coordinates of each corner of the plurality of corners of the at least one object. The at least one system processor 104 may be configured to determine the plurality of pixel coordinates based at least on the distance information of each pixel. The at least one system processor 104 may be configured to detect the plurality of corners by using the depth information received from the one or more sensors 114 or using deep learning protocols.

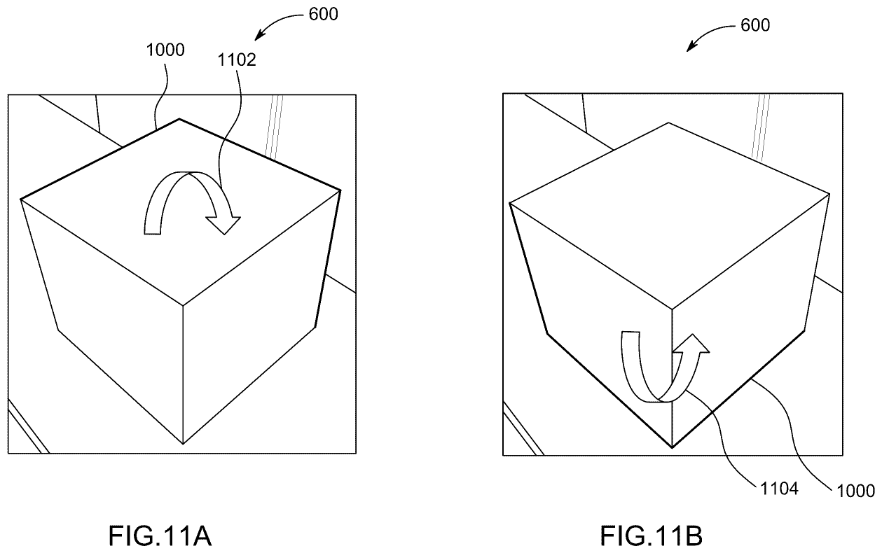

At operation 408, the at least one system processor 104 may be configured to determine, for at least one of the one or more coloured map images, the plurality of corner points of each corner of the plurality of corners of the at least one object based at least on the determined plurality of pixel coordinates. The plurality of corner points may comprise at least one of length coordinates, breadth coordinates, and height coordinates. In some embodiments, the at least one image capturing device 110 may be fine-tuned using a plurality of parameters. The plurality of parameters may comprise at least one of exposure, analog gain, and/or confidence threshold and a plurality of corrective measures, as described later in greater detail in conjunction with the description of FIG. 11. At operation 410, the at least one system processor 104 may be configured to map, for at least one of the one or more coloured map images, each corner point of the plurality of corner points to the respective predefined distance of the at least one object.

At operation 412, the at least one system processor 104 may be configured to determine the plurality of dimensions of the at least one object based at least on the mapping and the determined depth information. At operation 414, the at least one system processor 104 may be configured to display the plurality of dimensions of the at least one object on the at least one user device 108. In one example embodiment, the at least one system processor 104 may be configured to aggregate the one or more values decoded of the one or more one-dimensional barcodes and the one or more two-dimensional barcodes and the plurality of dimensions of the at least one object, for displaying on the display device of the user. The display device may correspond to the at least one user device 108, or any other computing device having a display, known in the art.

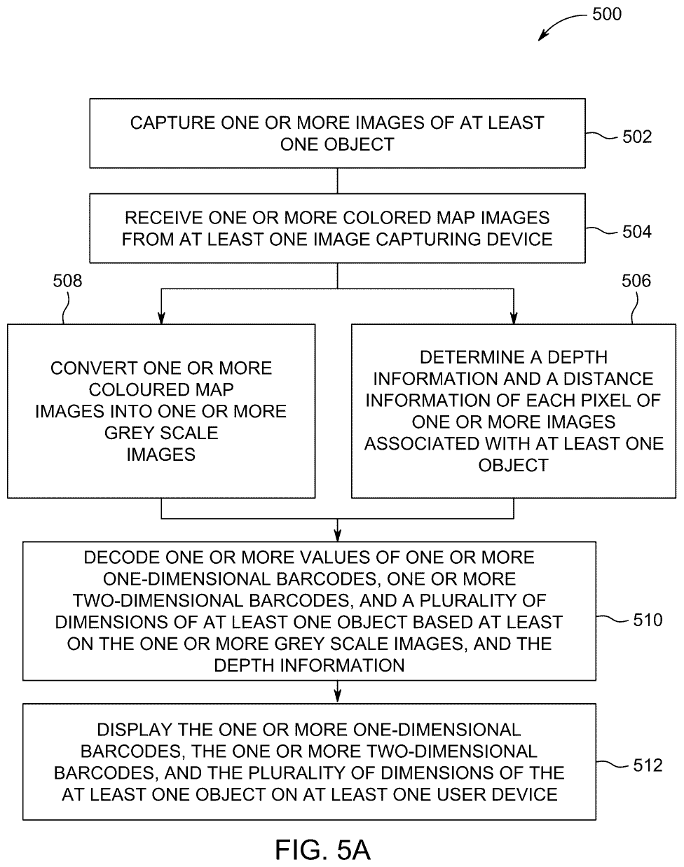

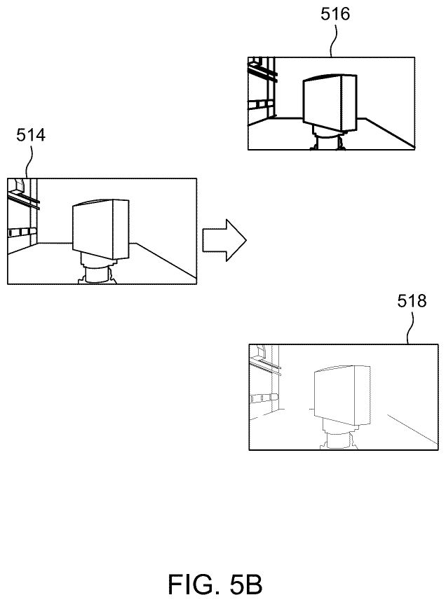

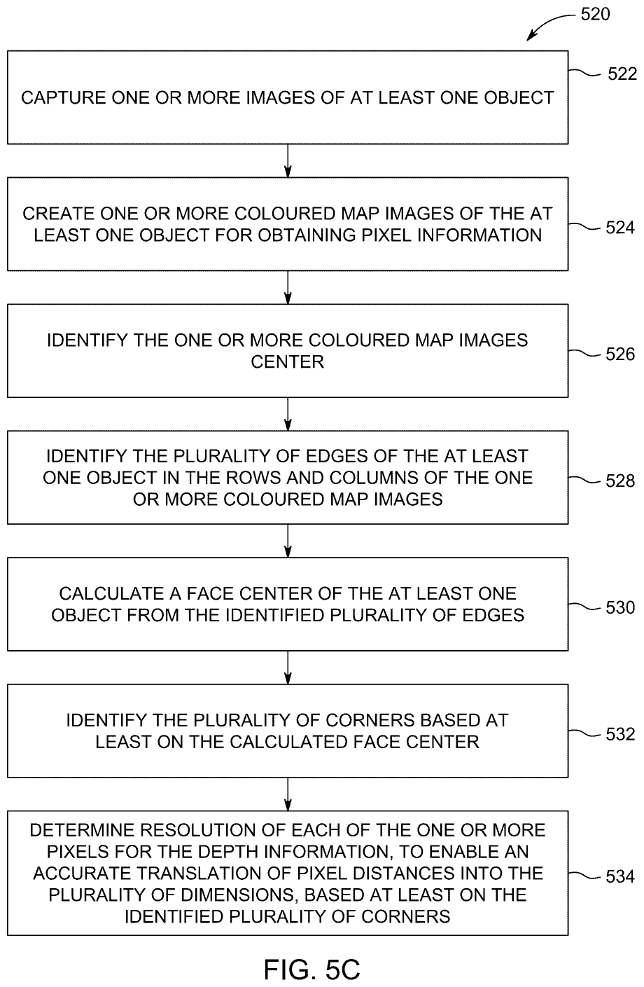

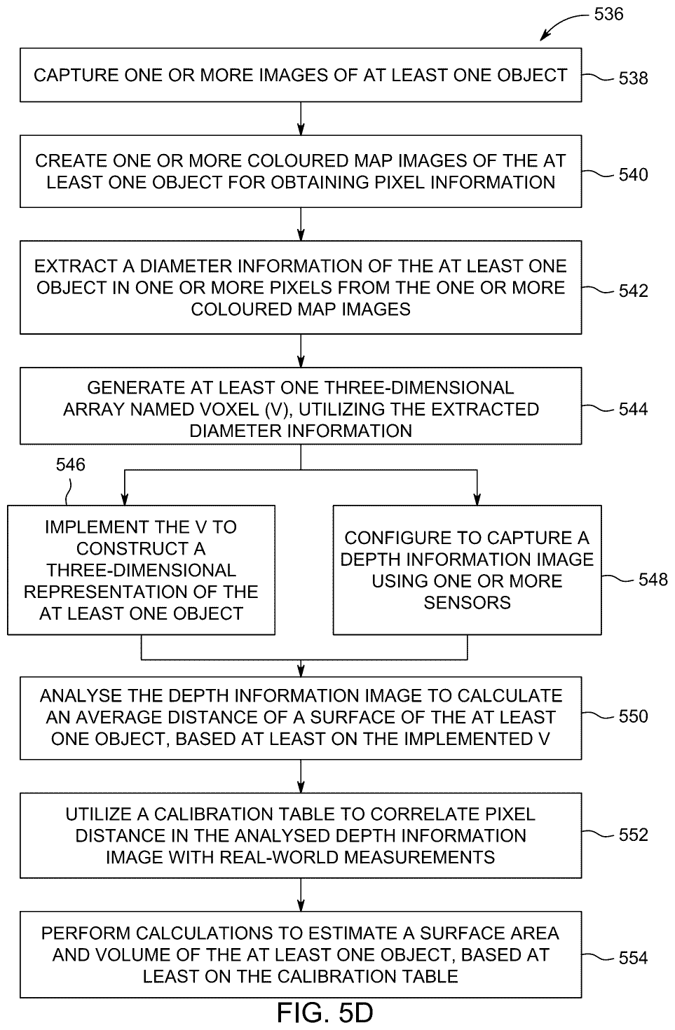

FIG. 5A illustrates a flowchart showing a method 500 for box dimensioning, in accordance with an example embodiment of the present disclosure.

At operation 502, the at least one image capturing device 110 via using the at least one image capturing device processor 112, may be configured to capture one or more images of the at least one object. At operation 504, the at least one system processor 104 may be configured to receive the one or more colored map images for obtaining pixel information. Further, the at least one system processor 104 may be configured to mask the one or more coloured map images. At operation 506, the one or more sensors 114 using the at least one sensor processor 116, may be configured to determine the depth information and the distance information of each pixel of the one or more images associated with the at least one object.

Simultaneous to the operation 506, at operation 508, the at least one system processor 104 may be configured to convert the one or more coloured map images into one or more grey scale images. At operation 510, the at least one system processor 104 may be configured to decode one or more values of the one or more one-dimensional barcodes, the one or more two-dimensional barcodes, and the plurality of dimensions of the at least one object based at least on the one or more grey scale images, and the depth information. At operation 512, the at least one system processor 104 may be configured to display the one or more one-dimensional barcodes, the one or more two-dimensional barcodes, and the plurality of dimensions of the at least one object on the at least one user device 108.

FIG. 5B illustrates the captured one or more images in the one or more coloured may images and in the one or more grey scale images, in accordance with an example embodiment of the present disclosure.

In alternate embodiments, the at least one image capturing device 110 may be configured to capture one or more grey scale images of at least one object, as illustrated by 514. Further, the at least one image capturing device 110 using the at least one image capturing device processor 112, may be configured to create the one or more coloured map images of the at least one object for obtaining pixel information, as illustrated by 516. In some embodiments, the one or more coloured map images may provide information about the at least one object visual characteristics. The one or more coloured map images may correspond a reference file that has binary data. The reference file may allow to detect a plurality of edges of the at least one object and manual allocation of the plurality of corners. Thereafter, the one or more sensors 114 may be configured to determine the depth information of each pixel of the one or more images associated with the at least one object. The depth information may be provided using a depth information image, as illustrated by 518. The depth information may provide a distance between a plane of the one or more sensors 114 and the plurality of edges of the at least one object.

FIG. 5C illustrates a flowchart showing a method 520 for box dimensioning of a regular shaped object, in accordance with an example embodiment of the present disclosure.

At operation 522, the at least one image capturing device 110 may be configured to capture one or more images of at least one object. The at least one object may correspond to a regular shaped object. The regular shaped object may have uniformity and symmetry in the structure of the at least one object. At operation 524, the at least one image capturing device 110 may be configured to create one or more coloured map images of the at least one object for obtaining pixel information. At operation 526, the at least one system processor 104 may be configured to identify the one or more coloured map images center. The at least one system processor 104 may be configured to identify the one or more coloured map images center based on the obtained pixel information.

At operation 528, the at least one system processor 104 may be configured to identify the plurality of edges of the at least one object in the rows and columns of the one or more coloured map images. The one or more one or more coloured map images may aid in image segmentation, highlighting only the one or more pixels associated with a face of the at least one object. Each of one or more pixels in the one or more coloured map images may correspond to a specific location on the face of the at least one object.

At operation 530, the at least one system processor 104 may be configured to calculate a face center of the at least one object from the identified plurality of edges. At operation 532, the at least one system processor 104 may be configured to identify the plurality of corners based at least on the calculated face center. The one or more coloured map images may allow for differentiation of one or more pixels, to analyse both vertical distance and horizontal distance between the one or more pixels. To convert the distance of each pixel from the one or more pixels into the plurality of dimensions, the depth information determined by the embedded one or more sensors 114 may be crucial. The captured depth information may be extracted and utilized in a calibration table. The calibration table may comprise at least information on correlating resolution of each pixel from the one or more pixels to depth information of each pixel.

At operation 534, the at least one system processor 104 may be configured to determine resolution of each of the one or more pixels for the depth information, to enable an accurate translation of pixel distance into the plurality of dimensions, based at least on the identified plurality of corners. Using the information from the calibration table, the system 100 may convert distance of each pixel form the one or more pixels obtained from the one or more coloured map images into accurate plurality of dimensions. The method 520 may allow for precise estimation of the size of the at least one object in both vertical and horizontal dimensions. In some embodiments, for estimating width of the at least one object, the rows may be multiplied with the resolution of each of the one or more pixels and for estimating height of the at least one object, the columns may be multiplied with the resolution of each of the one or more pixels.

FIG. 5D illustrates a flowchart showing a method 536 for box dimensioning of an irregular shaped object, in accordance with an example embodiment of the present disclosure.

At operation 538, the at least one image capturing device 110 may be configured to capture one or more images of at least one object. The at least one object may correspond to an irregular shaped object. In one example, the irregular shaped object may lack uniformity and symmetry in the structure of the at least one object. In another example, the irregular shaped object may have very less uniformity and symmetry in the structure of the at least one object. At operation 540, the at least one image capturing device 110 may be configured to create one or more coloured map images of the at least one object for obtaining pixel information. The one or more coloured map images may serve as a visual representation, aiding in the segmentation process. During segmentation, only the one or more pixels associated with the at least one object may be retained, effectively isolating the at least one object of interest. Each one of the one or more pixels within the segmented one or more coloured map images may provide information about the vertical and horizontal distance, that is then translated into size estimations, contributing to the 2D imaging aspect. In some embodiments, to convert pixel distance into precise plurality of dimensions, the system 100 may reply on the extraction of the depth information obtained from the one or more sensors 114. The depth information may enhance the accuracy of determination of the plurality of dimensions. In some embodiments, a critical component in achieving accurate plurality of dimensions may comprise a calibration table. The calibration table may serve as a reference, enabling the conversion of the distance information to the plurality of dimensions for each depth information.

At operation 542, the at least one system processor 104 may be configured to extract a diameter information of the at least one object in the one or more pixels from the one or more coloured map images. Extracting may involve identifying one or more boundaries of the at least one object and determining the distance of each of the one or more pixels across the diameter. At operation 544, the at least one system processor 104 may be configured to generate at least one three-dimensional array named voxel (V), utilizing the extracted diameter information. In the V, the generated V may represent a spatial distribution of the at least one object in a grid-like structure, with each V corresponding to a small volumetric unit.

At operation 546, the at least one system processor 104 may be configured to implement the V to construct a three-dimensional representation of the at least one object. The V may allow for a detailed and volumetric portrayal of the structure of the at least one object, capturing both external and internal features of the at least one object. Simultaneously, at operation 548, the at least one system processor 104 may be configured to capture a depth information image using the one or more sensors 114 The depth information image may provide information about the distance of each of the one or more pixels from the one or more sensors 114. The depth information may be crucial for accurate plurality of dimensions.

At operation 550, the at least one system processor 104 may be configured to analyse the depth information image to calculate an average distance of a surface of the at least one object, based at least on the implemented V. At operation 552, the at least one system processor 104 may be configured to utilize the calibration table to correlate pixel distance in the analysed depth information image with real-world measurements. As described in FIG. 5C, the calibration table may ensure that the plurality of dimensions may accurately represents the physical dimensions of the at least one object.

At operation 554, the at least one system processor 104 may be configured to perform calculations to estimate a surface area and volume of the at least one object, based at least on the calibration table. Moreover, for a user seeking to generate the detailed 3D model of the at least one object, the system 100 may support the capability by allowing the capture of the one or more multiple images from different angles using the at least one image capturing device 110. The iterative approach to capturing the one or more images may provide a comprehensive dataset, enhancing the fidelity and completeness of the resulting 3D model.

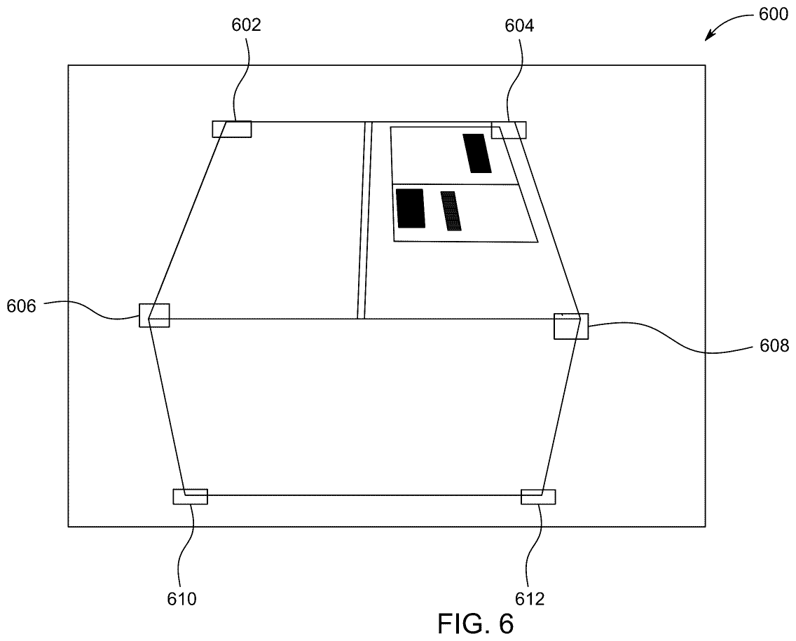

FIG. 6 illustrates at least one object 600 having a plurality of corners, in accordance with an example embodiment of the present disclosure.

As described above, the at least one system processor 104 may be configured to determine the plurality of pixel coordinates of each corner of the plurality of corners of the at least one object based at least on the distance information of each pixel. The at least one system processor 104 may be configured to detect the plurality of corners in the at least one object 600 by using the depth information received from the one or more sensors 114 or using deep learning protocols. In some embodiments, the at least one object 600 may correspond to a box. The at least one object 600 may correspond to a three-dimensional geometric shape that typically has at least six rectangular faces, twelve straight edges, and eight corners/vertices. The plurality of corners of the at least one object 600 may be points where a plurality of edges meets, forming a distinct intersection in space. Each of the plurality of corners of the at least one object 600 may be characterized by spatial coordinates that represents a specific point in three-dimensional space. The plurality of corners may play a crucial role in defining the shape and dimensions of the at least one object 600. It will be apparent to one skilled in the art that plurality of corners of the at least one object 600 are where the plurality of edges intersects, creating the plurality of corners that give a shape to the at least one object 600. The number of the plurality of corners on the at least one object 600 may be fixed and depend on the geometry of the at least one object 600. For the determination of the plurality of dimensions, the accurate identification and characterization of the plurality of corners is essential. The one or more algorithms may analyse the one or more captured images or utilize the depth information from the one or more sensors 114 to precisely detect and locate the plurality of corners. Understanding the plurality of corners allows for the calculation of the at least one object‘ 3D dimensions, such as the length, the breadth, and the height, contributing to accurate volume estimation and comprehensive dimensional information.

In one example embodiment, the at least one object 600 may comprise six corners. The six corners may correspond to a corner 602, a corner 604, a corner 606, a corner 608, a corner 610, and a corner 612. The corner 602, the corner 604, the corner 606, and the corner 608 are the plurality of corners of one face of the at least one object. The corner 606, the corner 608, the corner 610, and the corner 612 are the plurality of corners of another face of the at least one object.

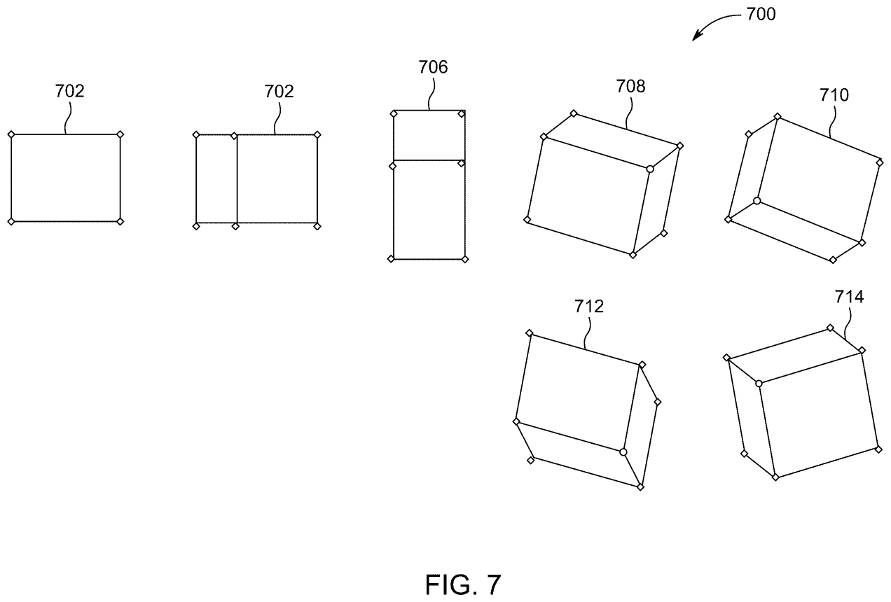

FIG. 7 illustrates a plurality of objects 700 similar to the at least one object 600 having the plurality of corners, in accordance with an example embodiment of the present disclosure.

As described above, the at least one system processor 104 may be configured to detect the plurality of corners in the at least one object 600 by using the depth information received from the one or more sensors 114 or using deep learning protocols. Similarly, the at least one system processor 104 may be configured to detect the plurality of corners in the plurality of objects 700. Further, the plurality of objects 700 may comprise at least one object 702, at least one object 704, at least one object 706, at least one object 708, at least one object 710, at least one object 712, and at least one object 714. In one example, the at least one object 702 may comprise four corners. In another example, the at least one object 704, and the at least one object 706 may comprise six corners. In yet another example, the at least one object 708, the at least one object 710, the at least one object 712, and the at least one object 714 may comprise seven corners, out of which at least one corner in each of the at least one object 708, the at least one object 710, the at least one object 712, and the at least one object 714 is a center corner, having the one or more different perspective views.

In some embodiments, the deep learning protocols may be utilized in several steps, beginning with detection of the at least one object 600 on the captured one or more images to identify the at least one object 600. Subsequently, image segmentation on the one or more images may be employed on the detected at least one object 600 to identify the plurality of corners of the at least one object 600 using the depth information obtained from the one or more sensors 114. In some embodiments, the deep learning protocols may initiate by detecting the plurality of corners of the at least one object 600. In any given positioning of the at least one object 600 and the at least one image capturing device 110, the deep learning protocols may ensure that at least four to seven corners of the at least one object 600 are visible. The presence of less than six corners in the detection of the at least one objects 600 may lead to immediate discarding of the one or more images. In one example, an ideal scenario may be to detect exactly six corners, with a center corner being optional.

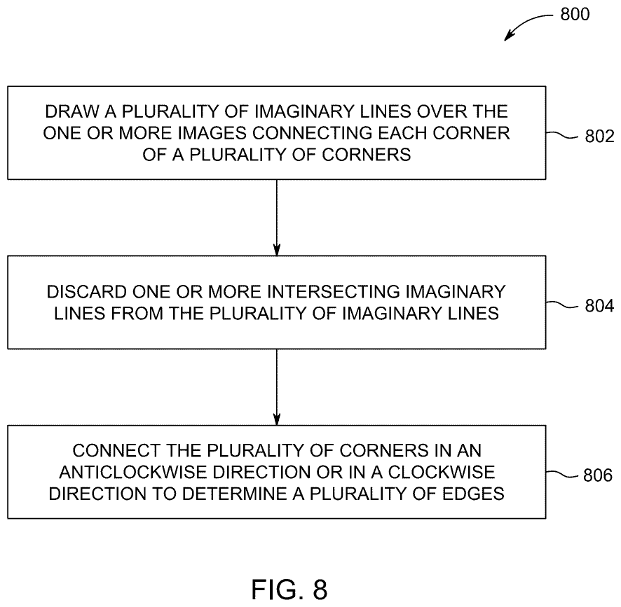

FIG. 8 illustrates a flowchart showing a method 800 to detect a plurality of edges of the at least one object 600, in accordance with an example embodiment of the present disclosure.

The at least one system processor 104 may be configured to select the captured one or more images of the at least one object 600 in which the plurality of corners of the at least one object 600 are visible. Further, the at least one system processor 104 may be configured to perform image segmentation. Thereafter, the at least one system processor 104 may be configured to determine the plurality of edges from the plurality of corners based at least on the performed image segmentation. At operation 802, the at least one system processor 104 may be configured to draw a plurality of imaginary lines over the one or more images connecting each corner of the plurality of corners. At operation 804, the at least one system processor 104 may be configured to discard one or more intersecting imaginary lines from the plurality of imaginary lines. In some embodiments, discarding the one or more intersecting imaginary lines from the plurality of imaginary lines may leave the plurality of imaginary lines to form the outer boundary of the at least one object. At operation 806, the at least one system processor 104 may be configured to connect the plurality of corners in an anticlockwise direction or in a clockwise direction to determine the plurality of edges.

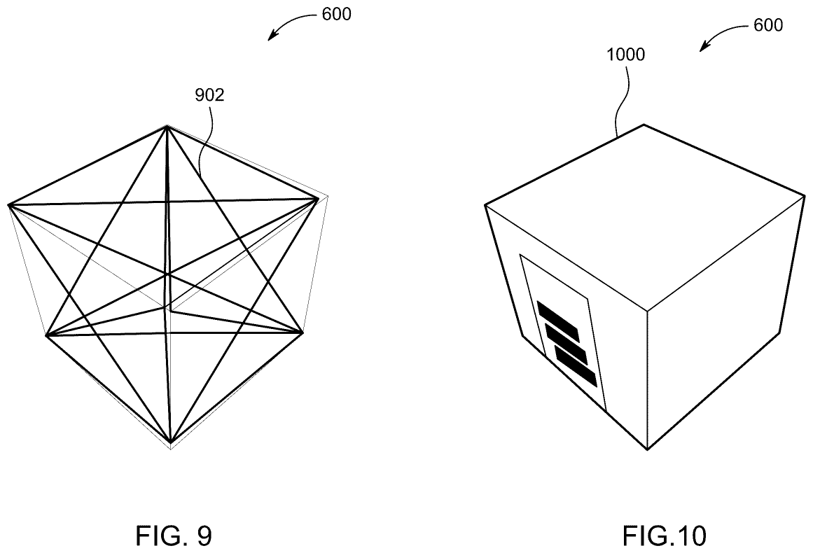

FIG. 9 illustrates the at least one object 600 having a plurality of imaginary lines connecting all the plurality of corner points, in accordance with an example embodiment of the present disclosure. FIG. 10 illustrates the at least one object 600 having an outer boundary 1000, in accordance with an example embodiment of the present disclosure.

In some embodiments, the at least one system processor 104 may be configured to perform image segmentation on the one or more images. Further, the at least one system processor 104 may be configured to perform image segmentation to determine the plurality of edges from the plurality of corners. The at least one system processor 104 may be configured to draw a plurality of imaginary lines over the at least one object 600 in the one or more images connecting each corner of the plurality of corners, as illustrated by 902 in FIG. 9. The plurality of imaginary lines may be drawn by connecting each corner of the plurality of corners of the at least one object 600, that are visible. Further, the at least one system processor 104 may be configured to discard one or more intersecting imaginary lines from the plurality of imaginary lines to form the outer boundary 1000, as illustrated in FIG. 10. In some embodiments, one or more intersecting imaginary lines connecting the plurality of corners that are visible, may be discarded. The one or more intersecting imaginary lines may be discarded to ensure that only the outer boundary 1000 remain in the FOV for the determination of the plurality of dimensions.

In some embodiments, from the outer boundary 1000, the at least one system processor 104 may select any one of the plurality of corners. Further, the at least one system processor 104 may be configured to connect the plurality of corners in the anticlockwise direction or in the clockwise direction to determine the plurality of edges. The connecting step may confirm the plurality of edges of the at least one object 600, defining the boundaries for accurate determination of the plurality of dimensions. With the plurality of edges, the at least one system processor 104 may further proceed to calculate the distance corresponding to the length, the breadth, and the height of the at least one object 600. The calculated distance may enable accurate estimation of volume of the at least one object 600, providing comprehensive dimensional information. The at least one system processor 104 may not only identify the plurality of corners and the plurality of edges but may also refine the data through careful elimination of the one or more intersecting imaginary lines, ultimately resulting in precise measurements and volume estimation for enhanced accuracy in various applications.

FIG. 11A illustrates the at least one object selecting at least one of the plurality of corner points from the formed outer boundary to traverse in the clockwise direction to connect with at least next three corner points from the plurality of corner points, in accordance with an example embodiment of the present disclosure.

In some embodiments, the at least one system processor 104 may be configured to connect the plurality of corners in in the clockwise direction, as illustrated by 1102. Traversing in the clockwise direction to connect the plurality of corners with the next at least three of the plurality of corners, may be describing a process to establish a sequential connection between the plurality of corners of the at least one object 600. The image segmentation for selecting the plurality of edges may begin by selecting one of the plurality of corners of the at least one object 600. The plurality corners may serve as a starting point for the sequential connection. The at least one system processor 104 may determine a direction of traversing from the plurality of corners. The determined direction may be clockwise direction. The determined direction may be maintained throughout the process of connecting the plurality of corners of the at least one object 600. Following the determined direction, the at least one system processor 104 may connect the plurality of corners with the next at least three of the plurality of corners in sequence. The connection of the plurality of corners may involve drawing the plurality of imaginary lines that are straight lines or the plurality of edges that link each of the plurality of corners to the next plurality of corners in the clockwise direction. As a result, a series of the plurality of edges that are connected may be formed, effectively outlining a portion of the outer boundary 1000. In some embodiments, the plurality of corners connected in the clockwise manner may help to define the plurality of edges of the at least one object 600 and contribute to the confirmation of the overall shape of the at least one object 600. The sequential connection of the plurality of corners in the clockwise direction may aid in confirming the plurality of edges of the at least one object 600. By connecting the plurality of corners, the at least one system processor 104 may ensure that the plurality of edges are part of the structure of the at least one object, contributing to the determining accurate plurality of dimensions.

FIG. 11B illustrates the at least one object selecting at least one of the plurality of corner points from the formed outer boundary to traverse in the anticlockwise direction to connect with the at least next three corner points from the plurality of corner points, in accordance with an example embodiment of the present disclosure.

In some embodiments, the at least one system processor 104 may be configured to connect the plurality of corners in in the anti-clockwise direction, as illustrated by 1104. Traversing in the anti-clockwise direction to connect the plurality of corners with the next at least three of the plurality of corners, may be describing a process to establish a sequential connection between the plurality of corners of the at least one object 600. The image segmentation for selecting the plurality of edges may begin by selecting one of the plurality of corners of the at least one object 600. The plurality corners may serve as a starting point for the sequential connection. The at least one system processor 104 may determine a direction of traversing from the plurality of corners. The determined direction may be anti-clockwise direction. The determined direction may be maintained throughout the process of connecting the plurality of corners of the at least one object 600. Following the determined direction, the at least one system processor 104 may connect the plurality of corners with the next at least three of the plurality of corners in sequence. The connection of the plurality of corners may involve drawing the plurality of imaginary lines that are straight lines or the plurality of edges that link each of the plurality of corners to the next plurality of corners in the anti-clockwise direction. As a result, a series of the plurality of edges that are connected may be formed, effectively outlining a portion of the outer boundary 1000. In some embodiments, the plurality of corners connected in the anti-clockwise manner may help to define the plurality of edges of the at least one object 600 and contribute to the confirmation of the overall shape of the at least one object 600. The sequential connection of the plurality of corners in the anti-clockwise direction may aid in confirming the plurality of edges of the at least one object 600. By connecting the plurality of corners, the at least one system processor 104 may ensure that the plurality of edges are part of the structure of the at least one object, contributing to the determining accurate plurality of dimensions.

With the plurality of edges, the at least one system processor 104 may further proceed to calculate the distance corresponding to the length, the breadth, and the height. The calculated distance may enable accurate estimation of volume of the at least one object 600, providing comprehensive dimensional information.

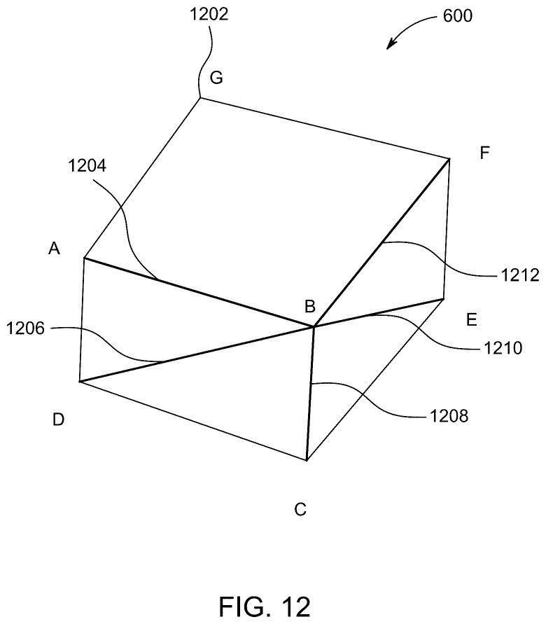

FIG. 12 illustrates the plurality of edges selected in the at least one object 600, in accordance with an example embodiment of the present disclosure.

As described above, the at least one system processor 104 may be configured in a series of steps designed to identify the plurality of corners and the plurality of edges of the at least one object 600. In some embodiments, the at least one system processor 104 may comprise a prerequisite that at least four to at least seven of the plurality of corners of the at least one object 600 should be visible in any given positioning of the at least one object 600. In one case, if the number of the plurality of corners falls below six, the one or more images may be promptly discarded. In another case, if at least six or seven of the plurality of corners are detected, the at least one system processor 104 may filter the plurality of corners for enhanced accuracy in image segmentation.

In another case of the detection of the at least six or seven corners, the at least one system processor 104 may discard each corner from the plurality of corners with a highest depth value. For example, a corner 1202 denoted as “G” having a highest depth value may be discarded. Subsequently, all the plurality of imaginary lines originating from the plurality of corners with a least depth value may be considered. For example, an imaginary line originating from G, having a least depth value may be discarded. In some embodiments, a plurality of imaginary lines may be considered. In one example embodiment, the plurality of imaginary lines may comprise an imaginary line 1204 denoted as “BA”, an imaginary line 1206 denoted as “BD”, an imaginary line 1208 denoted as “BC”, an imaginary line 1210 denoted as “BE”, and an imaginary line 1212 denoted as “BF”, that become the focal points.

In some embodiments, two distinct cases may arise in the analysis of the plurality of imaginary lines. The two distinct case may comprise a face diagonal case, and an edge case. In the face diagonal case, if the plurality of imaginary lines that are selected is identified as a face diagonal, such as BD, that inherently has only one of the perpendicular plurality of edges, such as BF, the at least one processor may select BF as one of the edge from the plurality of edges of the at least one object 600. Further, the BF may be selected, and at least two-line segments perpendicular to BF, such as BA and BC, may be identified as the other two of the plurality of edges of the at least one object 600.

In the edge case, if the plurality of imaginary lines that are selected is recognized as the plurality of edges, such as BF, each of the plurality of edges has at least three perpendicular line segments, such as BA, BD, and BC associated with BF. The at least one system processor 104 may discard the longest perpendicular imaginary line, that is, BD, among the BA, BD and BC, leaving the BA and BD as the edges from the plurality of edges of the at least one object 600. In some embodiments, upon confirming the plurality of edges, the at least one system processor 104 may calculate the distance, encompassing the length, the breadth, and the height. The comprehensive data enables the precise estimation of the volume of the at least one object 600, ensuring that the dimensioning process is not only rapid but also highly accurate.

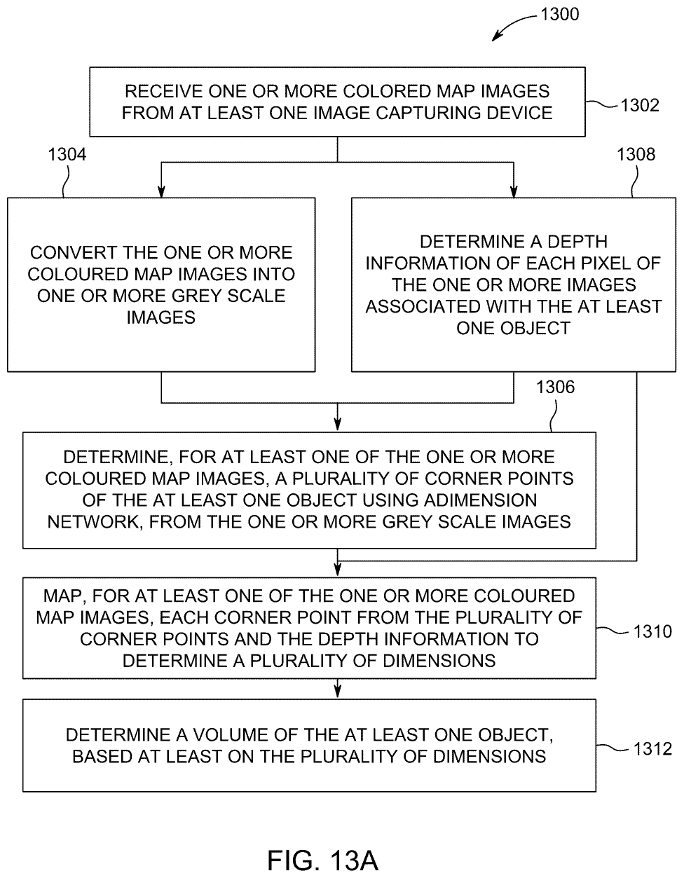

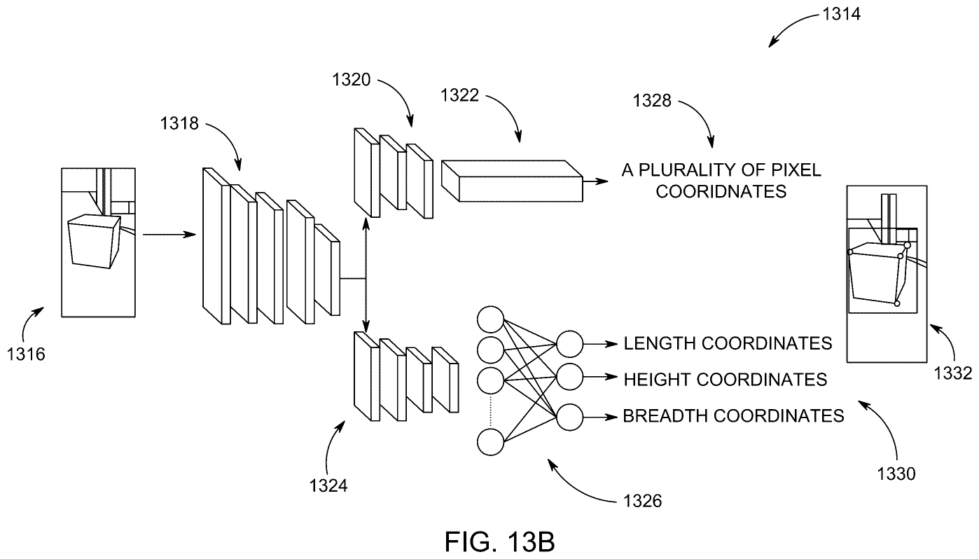

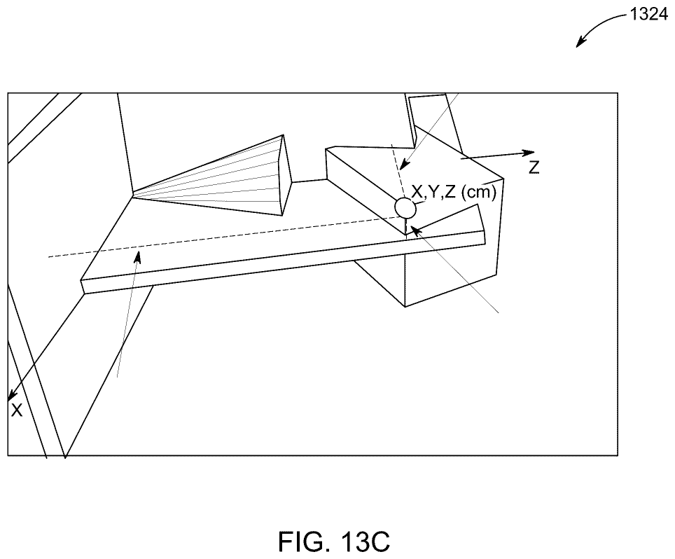

FIG. 13A illustrates a flowchart of a method 1300 of a dimensioning architecture of the system 100, in accordance with an example embodiment of the present disclosure. FIG. 13B illustrates a dimension network 1314 of the dimensioning architecture, in accordance with an example embodiment of the present disclosure.

At operation 1302, the at least one image capturing device 110 may be configured to capture one or more images of the at least one object 600. As described above, the at least one image capturing device 110 may be configured to create one or more coloured map images of the at least one object 600 for obtaining pixel information. The created one or more coloured map images image may be essential for the image segmentation of the one or more images, displaying only the one or more pixels associated with a face boundary of the at least one object 600. Each of the one or more pixels in the one or more created one or more coloured map images may represent vertical distance and horizontal distance, contributing to the size estimation of the at least one object 600. At operation 1304, the at least one system processor 104 may be configured to convert the one or more coloured map images into one or more grey scale images 1316.

At operation 1306, the at least one system processor 104 may be configured to determine, for at least one of the one or more coloured map images, the plurality of corner points of the at least one object using the dimension network 1314, from the one or more grey scale images. The dimension network 1314 may correspond to deep learning protocols. In some embodiments, the dimension network 1314 may be designed for detection of the plurality of corners points from the one or more grey scale images 1316. The dimension network 1314 may deploy a deep learning network having convolutional layers, pooling layers, and normalization layers. The one or more grey scale images 1316 may be processed through a convolutional neural network (CNN) backbone 1318 with one or more weights. In one example, the one or more weights may correspond to trained weights from a custom dataset. Further, one or more features extracted from the CNN backbone 1318 may be directed into two branches. In one example, the two branches may correspond to CNN network. Further, the two branches may comprise at least one object detection branch 1320 having a bounding box network 1322 and a plurality of corners detection branch 1324 having a fully connected network 1326. The at least one object detection branch 1320 may identify the at least one object 600 of interest and estimate the plurality of pixel coordinates of the at least one object 600, as illustrated by 1328 in FIG. 13B. The plurality of corners detection branch 1324 may calibrate the plurality of corners of the at least one object 600 to provide the plurality of corner points comprising at least one of length coordinates, breadth coordinates, and height coordinates of the at least one object 600, as illustrated by 1330 in FIG. 13B.

Simultaneous to operation 1304, at operation 1308, the one or more sensors 114 may be configured to determine the depth information of each pixel of the one or more images associated with the at least one object 600. At operation 1310, the at least one system processor 104 may be configured to map, for at least one of the one or more coloured map images, each corner point from the plurality of corner points and the depth information to determine the plurality of dimensions, as illustrated by 1332 in FIG. 13B. The at least one system processor 104 may associate the values of each corner point from the plurality of corner points in the one or more images with the depth information. Utilizing the depth information, the at least one system processor 104 may determine the actual position of the at least one object 600 in the real-world. In some embodiments, the calibration table, as described in FIG. 5C, may be employed to obtain the resolution of the one or more pixels for each depth information, facilitating the conversion of the values of each corner points to the plurality of dimensions in millimetres (mm). At operation 1312, the at least one system processor 104 may be configured to determine a volume of the at least one object 600, based at least on the plurality of dimensions.

FIG. 13C illustrates an exemplary scenario 1334 of the dimensioning architecture, in accordance with an example embodiment of the present disclosure.

In some embodiments, a value (X₁, Y₁) as the one or more pixel coordinates may be considered. The value (X₁, Y₁) may be detected by the at least one system processor 104 as a corner. Now the at least one system processor 104 may consider the corresponding depth information of the detected value (X₁, Y₁) and determine a corresponding value (Z₁) of the real-world value. The corresponding value (Z₁) may be a project value on a XY plane of the exemplary scenario 1334. Further, the at least one system processor 104 may have a value (X₁, Y₁, Z₁). Thereafter, the at least one system processor 104 may convert the values (X₁, Y₁, Z₁) to a value (X₂, Y₂, Z₂). The value (X₂, Y₂, Z₂) may correspond to an actual point in the real-world with respect to the at least one image capturing device 110. In one example embodiment, the value (Y₂) may be a projected value on a XZ plane of the exemplary scenario 1334. The at least one system processor 104 may be configured to determine a distance “d” of the at least one real-world point based on the values (X₁, Y₁, Z₁) to the value (X₂, Y₂, Z₂), using a formula:

$$d = {( {( {X}_{2} - {X}_{1} )}^{2} + {( {Y}_{2} - {Y}_{1} )}^{2} + {( {Z}_{2} - {Z}_{1} )}^{2} )}^{1 / 2} .$$

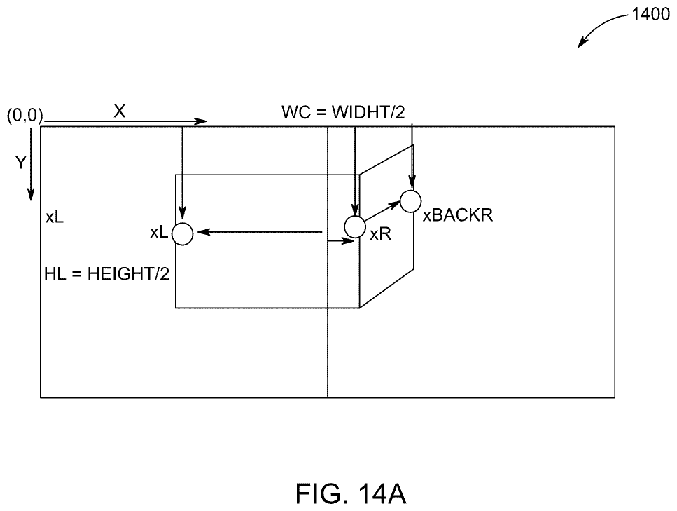

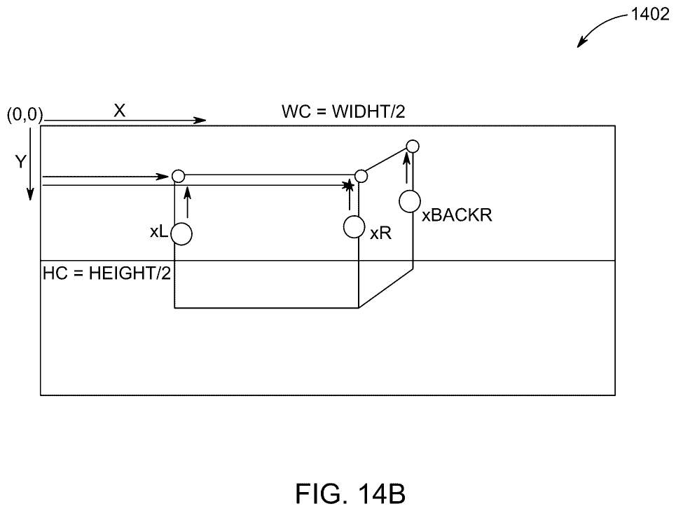

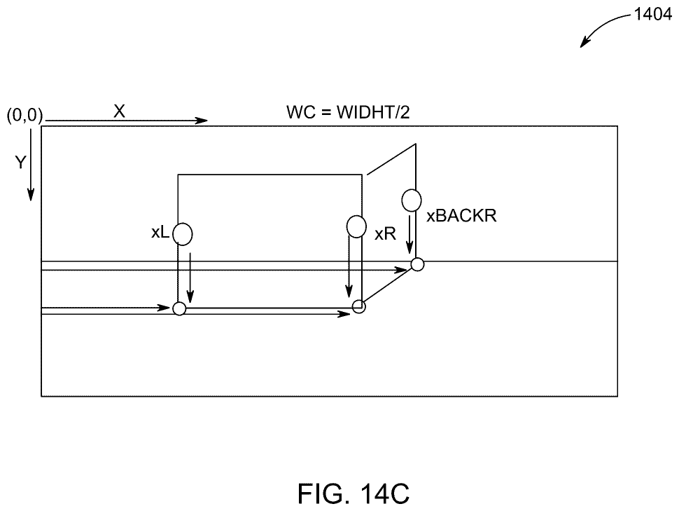

FIG. 14A illustrates a left limit and a right limit in the one or more images of the at least one object 600, in accordance with an example embodiment of the present disclosure.

In some embodiments, the left limit and the right limit may be defined using one or more input variables and one or more output variables such as: void imagecorners (unsigned char* imagein, float* depth, double* H_Ave, double* L_Ave, double* W_Ave, int W, int H)

The one or more input variables may comprise the “unsigned char* imagein” corresponding to a pointer to colored depth image unit, the “float* depth” corresponding to a pointer to depth image information float data, and “int W, int H” corresponding to a width and height image. The one or more output variables may comprise the “double* H_Ave” corresponding to a height of package, the “double* L_Ave” corresponding to a length of package, and the “double* W_Ave” corresponding to a width of package.

In some embodiments, an exemplary scenario 1400 may be illustrated. In the exemplary scenario 1400, via the at least one system processor 104 may be configured to count one or more pixels from center to an edge in left direction. Further, the at least one system processor 104 may be configured to count one or more pixels from center to the edge in right direction.

The exemplary scenario 1400 may illustrate an algorithm based on manual strategy. The algorithm may be executed by the at least one system processor 104 to find horizontal limit edge in the at least one object 600. The manual strategy may be based on the algorithm that evaluate one or more pixels in a same row or column and further, stop until a pixel with value related to the colored map is found. The algorithm may comprise the steps of finding the first pixel with values from image center in a coordinate X. The coordinate X may be defined by width/2 denoted as “WC”. Further, the algorithm may comprise the steps of finding the first pixel with values related to one or more colored map images in the same horizontal row. Further, going to left, the algorithm may comprise the steps of saving the left limit denoted by XL. Thereafter, going to right, the algorithm may comprise the steps of saving the first Right limit denoted by XR. In one example embodiment, the limit after XR may be named as “XBackR”.

FIG. 14B illustrates one or more top values of the left limit and the right limit of the at least one object 600, in accordance with an example embodiment of the present disclosure.

In some embodiments, an exemplary scenario 1402 may be illustrated. In the exemplary scenario 1402, the at least one system processor 104 may be configured to determine one or more top values of the one or more pixels counted from center to the edge in the left direction. Further, the at least one system processor 104 may be configured to determine one or more top values of the one or more pixels counted from center to the edge in the right direction. The one or more top values may be configured to save the one or more pixel coordinates and depth information of the at least one object 600.

In some embodiments, the exemplary scenario 1402 may illustrate that the algorithm may comprise the steps of finding top coordinates or one or more top values after obtaining XL, XR and XBackR. The algorithm may comprise the steps of finding the top limits in the same column from XL, XR and XBackR.

FIG. 14C illustrates one or more bottom values of the left limit and the right limit of the at least one object 600, in accordance with an example embodiment of the present disclosure.

In some embodiments, an exemplary scenario 1404 may be illustrated. In the exemplary scenario 1404, the at least one system processor 104 may be configured to determine one or more bottom values of the one or more pixels counted from center to the edge in the left direction. Further, the at least one system processor 104 may be configured to determine one or more top values of the one or more pixels counted from center to the edge in the right direction. The one or more top values may be configured to save the one or more pixel coordinates and depth information of the at least one object 600.

In some embodiments, the exemplary scenario 1404 may illustrate that the algorithm may comprise the steps of obtaining bottom coordinates or the one or more bottom values for finding edge manually. The algorithm may comprise the steps of finding the top limits in the same column from XL, XR and XBackR.

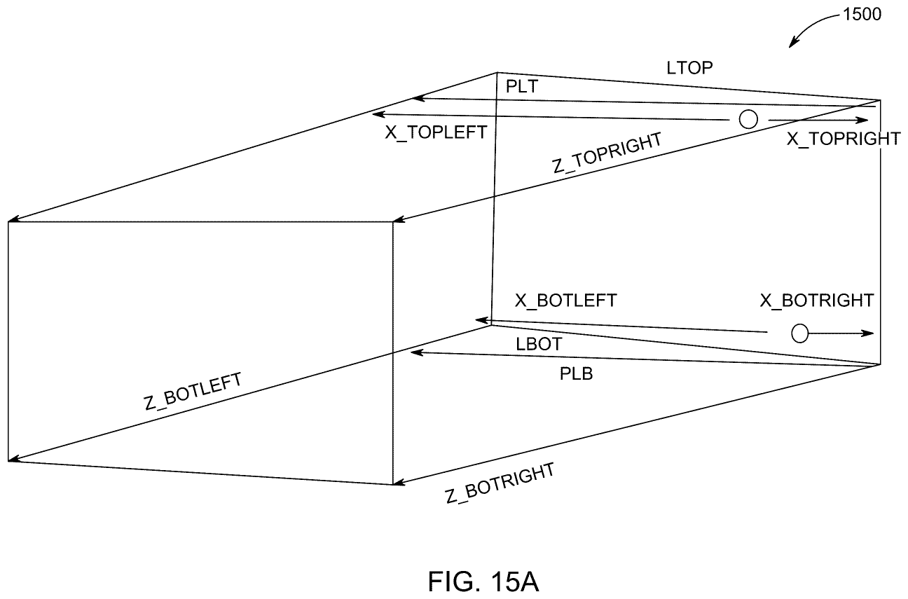

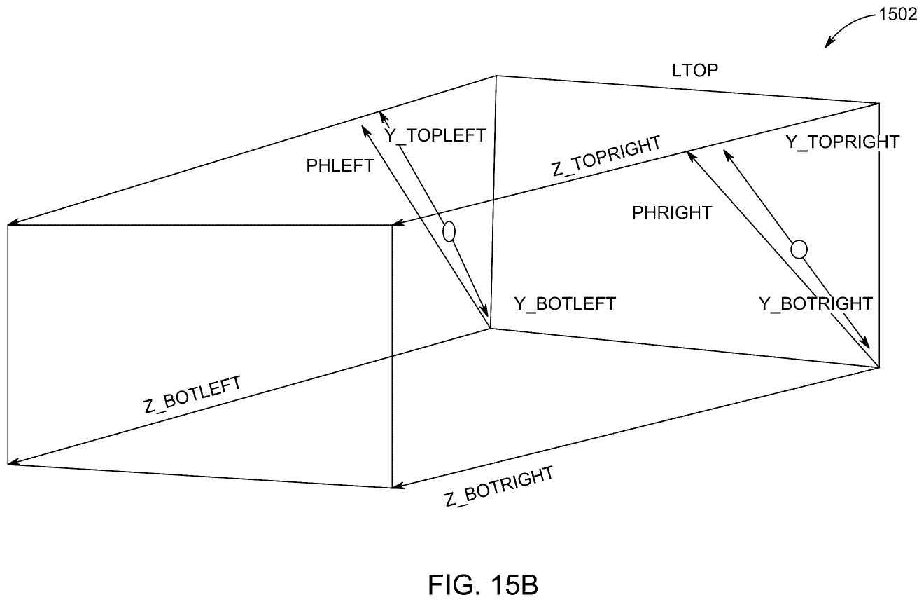

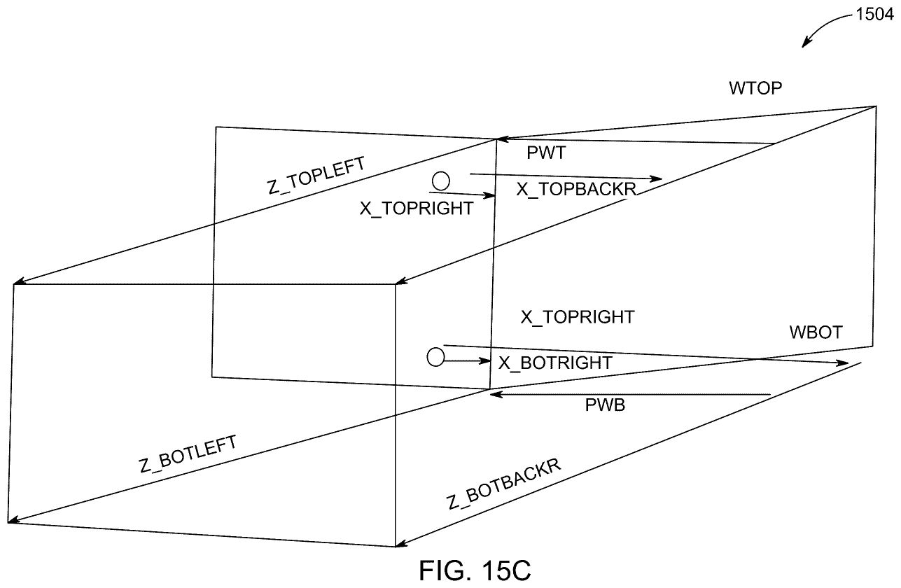

FIG. 15A illustrates determination of a real-world length of the at least one object 600, in accordance with an example embodiment of the present disclosure.

In some embodiments, a plurality of coordinates may be defined using one or more instructions executed by the at least one system processor 104. The plurality of coordinate may comprise one or more pixel coordinates and “Z” coordinate in the real-world. The depth of the “Z” coordinate in real-world may be in centimeters (cms) unit. The one or more pixel coordinates may correspond to “xL,y_TopLeft”, “xR,y_TopRight”, “xBackR,y_TopBackR”, “xL,y_BotLeft”, “xR,y_BotRight”, and “xBackR,y_BotBackR”. The “Z” coordinate in the real-world may correspond to “Z_TopLeft”, “Z_TopRight”, “Z_TopBackR”, “Z_BotLeft”, “Z_BotRight”, and “Z_BotBackR”.

In some embodiments, an exemplary scenario 1500 may be illustrated. In the exemplary scenario 1500, an algorithm may cause the at least one system processor 104 to determine real-world length of the at least one object 600. The real-world length may correspond to distance of length denoted by “L”. The at least one system processor 104 may use the algorithm to find values of the coordinates from the one or more colored map images. The values may comprise the “Z_TopLeft, Z_TopRight, Z_Botleft, Z_BotRight” that may be used as input Z and may further generate X_distance and Y_distance in the real-world for each value of the values.

FIG. 15B illustrates determination of a real-world height of the at least one object, in accordance with an example embodiment of the present disclosure.

In some embodiments, an exemplary scenario 1502 may be illustrated. In the exemplary scenario 1502, the at least one system processor 104 may be configured to determine real-world height of the at least one object 600. The real-world height may correspond to distance of height denoted by “Y”. The real-world height may be in cms unit.

FIG. 15C illustrates determination of a real-world width of the at least one object, in accordance with an example embodiment of the present disclosure.

In some embodiments, an exemplary scenario 1504 may be illustrated. In the exemplary scenario 1504, the at least one system processor 104 may be configured to determine real-world width of the at least one object 600. The real-world width may be in cms unit.

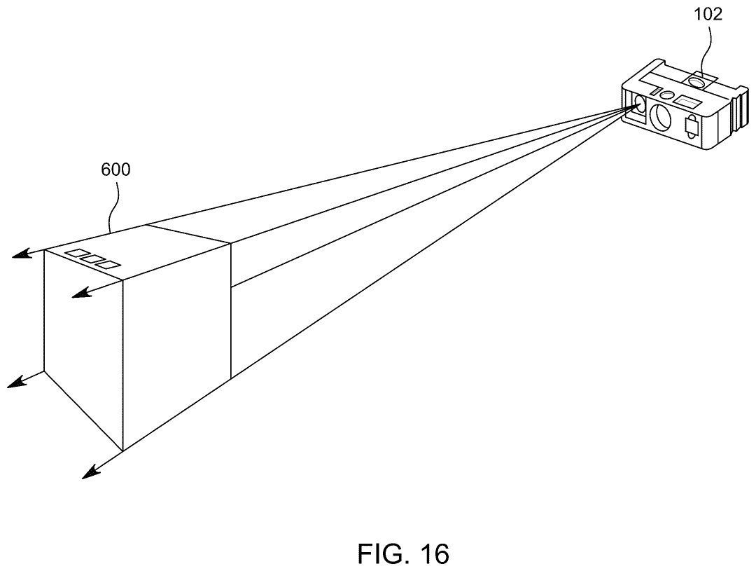

FIG. 16 illustrates the scanner 102 of the system 100, in accordance with an example embodiment of the present disclosure.

In some embodiments, the scanner 102 may present a novel approach to integrated 3D dimensioning and 2D barcode scanning using at least one image capturing device 110 and the one or more sensors 114. In one example embodiment, the one or more sensors 114 may correspond to the CMOS sensor with layers of diffractive structure. The diffractive structure may induce a Talbot effect based at least on a distance of the at least one object 600 from the scanner 102. The Talbot effect may enable the CMOS sensor to capture the depth information associated with the at least one object. In some embodiments, the scanner 102, may showcase the ability to simultaneously scan the one or more one-dimensional barcodes, the one or more two-dimensional barcodes and the plurality of dimensions of the at least one object 600 in a single capture. The scanner 102 may employ a fixed focus lens for capturing the one or more images with the depth information. However, to address limitations in the depth of the FOV at a variable working distance, the scanner 102 may incorporate a tunable lens for enhanced accuracy.

In some embodiments, the tunable lens may be communicatively coupled to the at least one image capturing device 110. Further, the tunable lens may be configured to fine-tune a plurality of parameters of the at least one image capturing device 110. The tunable lens may comprise a voice coil motor. The voice coil motor may be configured to adjust distance between a plurality of lens elements of the at least one image capturing device 110 and for varying F numbers. In some embodiments, the plurality of parameters may comprise at least one of exposure, analog gain, and/or confidence threshold and a plurality of corrective measures. The plurality of corrective measures may comprise lightning conditions, background contrast, reduce reflection, and repositioning of the at least one image capturing device 110.

In some embodiments, the exposure may determine the amount of light reaching the one or more sensors 114. In one example, the one or more sensors 114 may correspond to an image sensor. The exposure may be influenced by such as shutter speed, lens F-number, and scene luminance. In the 3D dimensioning, adjusting the exposure helps optimize the balance between capturing enough light for the accurate depth measurement and preventing overexposure. In some embodiments, the analog gain may refer to the amplification of the signal from the one or more sensors 114. Increasing the analog gain may enhance the brightness or sensitivity of the one or more images. The analog gain may be calibrated for fine-tuning a response of the one or more sensors 114 to the light, ensuring that the depth information is captured with optimal sensitivity and accuracy. In some embodiments, the confidence threshold may represent the minimum level of certainty required for the depth information to be deemed acceptable. The confidence threshold may be calibrated for filtering out unreliable or noisy depth information, ensuring that only confident and accurate measurements contribute to the determination of the plurality of dimensions.

In some embodiments, the tunable lens system may adapt to varying the working distance, ranging from 1 meters (m) to 3 m, depending on focal length of the tunable lens. The adaptability may be achieved through a design of the tunable lens, involving a plurality of lens elements and the voice coil motor for adjusting focus of the tunable lens. The design of the tunable lens may facilitate real-world adjustments of the F numbers. The F number may be a critical parameter governing an aperture size of the plurality of lens elements. In applications where both high-accuracy 3D dimensioning and a broad barcode reading range is essential, a trade-off may be needed between the required F numbers for the accurate 3D measurement and the required F numbers for the broad barcode reading range. In one example embodiment, the F number may be varied between 1.5 and 6, offering flexibility in capturing the one or more images tailored to the needs of the at least one image capturing device 110.

Further, for determining the plurality of dimensions, a small F number may be required for the plurality of lens elements, such as between 1 and 2, allowing for precise depth information. For an effective barcode reading range, a larger F number of around 5-6 may be preferred, as the larger F number may facilitate capturing the one or more images with a broader depth of the FOV. In some embodiments, the tunable lens may dynamically change the F number of the plurality of lens elements in real-world. The tunable lens may be crucial for adapting to different operational requirements without the need for manual adjustments or changes in the plurality of lens elements. The tunable lens may operate within a millisecond range, enabling swift and precise adjustments to the at least one image capturing device 110.

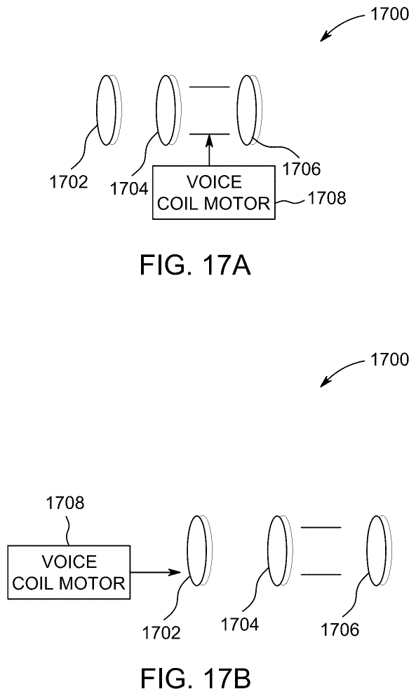

FIG. 17A illustrates a tunable lens 1700 with variable stop size, in accordance with an example embodiment of the present disclosure.

The plurality of lens elements may comprise a lens 1702, a lens 1704, and a lens 1706. In one example embodiment, a voice coil motor 1708 may be employed to adjust stop size of the plurality of lens elements, enabling dynamic tuning of the F number between 1.5 and 6. The voice coil motor 1708 may tune the lens 1702, the lens 1704, and the lens 1706 to adjust stop size. The tuning may allow the scanner 102 to capture the one or more images with F number of 1.5 for determination of the plurality of dimensions and the one or more images with F number of 6 for decoding the value of the one or more one-dimensional barcodes and the one or more two-dimensional barcodes, in real-world, with tuning times in the millisecond range. The rapid tuning capability may enable the scanner 102 to capture a sequence of the one or more images for both the one or more one-dimensional barcodes, the one or more two-dimensional barcodes, and the plurality of dimensions within seconds.

FIG. 17B illustrates the tunable lens 1700 with variable focal length, in accordance with an example embodiment of the present disclosure.

In one example embodiment, the voice coil motor 1708 may be employed to adjust the focal length of the plurality of lens elements. The voice coil motor 1708 may tune the lens 1702, the lens 1704, and the lens 1706 to adjust the focal length. Further, the focal length of the plurality of lens elements may be tuned between two values while maintaining a fixed stop size. The shorter focal length may correspond to a F number of 1.5, optimized for the determination of the plurality of dimensions. Further, the longer focal length may correspond to a F number of 6, ideal for decoding the value of the one or more one-dimensional barcodes and the one or more two-dimensional barcodes. The voice coil motor 1708 may adjust the distance between the plurality of lens elements, providing the plurality of lens elements with two distinct focal lengths, accommodating both the one or more one-dimensional barcodes, the one or more two-dimensional barcodes, and the plurality of dimensions.

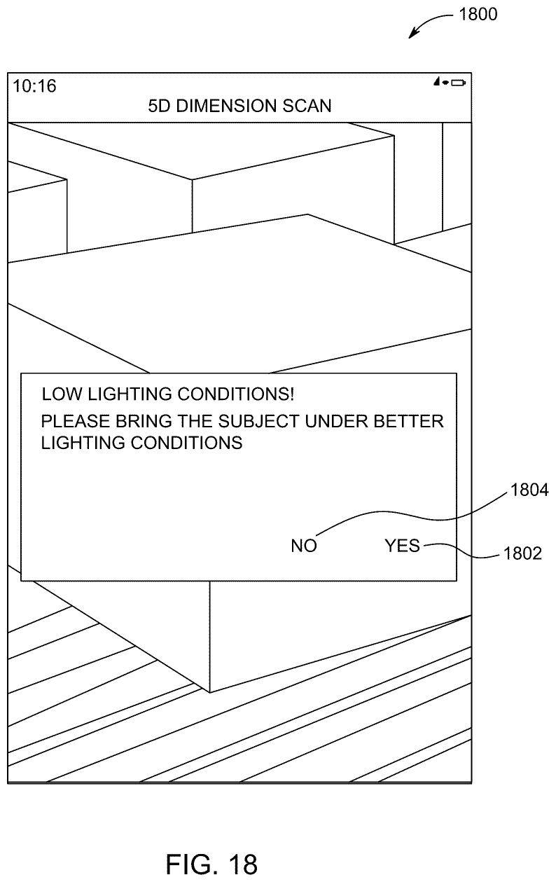

FIG. 18 illustrates a user interface (UI) 1800 of a feedback for taking the plurality of corrective measures, in accordance with an example embodiment of the present disclosure.

As described above, the tunable lens 1700 may be configured to fine-tune the plurality of parameters of the at least one image capturing device 110. In some embodiments, the plurality of parameters may comprise at least one of exposure, analog gain, and/or confidence threshold and the plurality of corrective measures. The tunable lens may adjust the plurality of parameters until satisfactory depth information is achieved, typically the plurality of corners of the at least one object 600.

In some embodiments, even after fine tuning the plurality of parameters, the at least one image capturing device 110 may not yield satisfactory results, as a result, the system 100 may provide the feedback to the one or more users of the at least one user device. The feedback may prompt the one or more users to take the plurality of corrective measures. The plurality of corrective measures may comprise lightning conditions, background contrast, reduce reflection, and repositioning of the at least one image capturing device 110, improving illumination, enhancing contrast difference, and reflection reduction measures. In some embodiments, fine tuning the lighting conditions around the at least one object 600 may significantly impact the accuracy of the depth information. The one or more users may be advised to experiment with different lighting conditions to find an arrangement that enhances the performance of the at least one image capturing device 110.

In some embodiments, repositioning of the at least one image capturing device 110 may help to achieve better depth information. The repositioning of the at least one image capturing device 110 may allow the one or more users to find an optimal setup that minimizes the impact of environmental factors on depth information. In some embodiments, the one or more users may be prompted to improve illumination by turning on the flashlight of the at least one image capturing device 110 or using additional illumination sources. Improved illumination may positively influence the ability of the scanner 102 to accurately detect the plurality of corners and calculate the depth information. In some embodiments, improving the background contrast may aid in the plurality of corners detection. The one or more users may receive guidance on adjusting the background contrast to enhance contrast, thereby facilitating more accurate depth information. In some embodiments, to address issues related to reflective surfaces, the one or more users may be advised to take measures to reduce reflection. Reflection reduction may involve altering the positioning of the at least one object 600, using anti-reflective coatings, or modifying the illumination setup.

Further, the UI 1800 may provide a feedback to one or more user on the at least one user device. In one example, the feedback may indicate the one or more users about lighting conditions as “LOW LIGHTING CONDITIONS!”. Further, the feedback may comprise a message as “Please Bring the subject under better lighting conditions”. In one embodiment, the one or more users may be prompted by the UI 1800 to either accept the corrective measure by selecting the “YES” button, as illustrated by 1802, or reject the corrective measure by selecting the “NO” button, as illustrated by 1804, on the UI 1800.

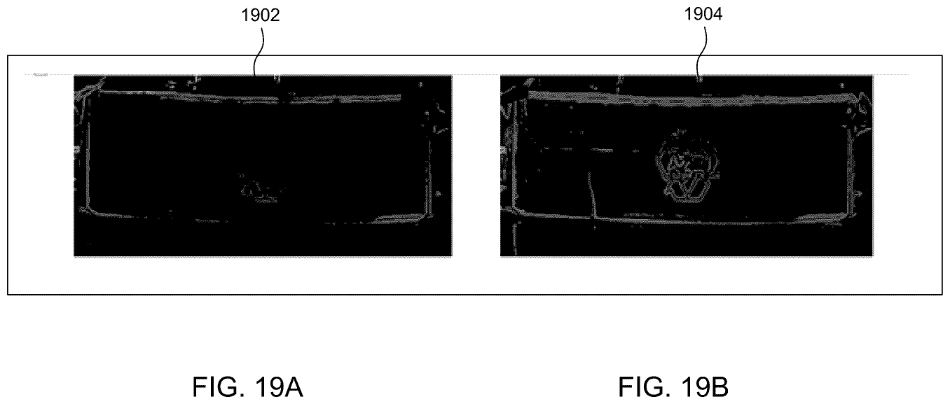

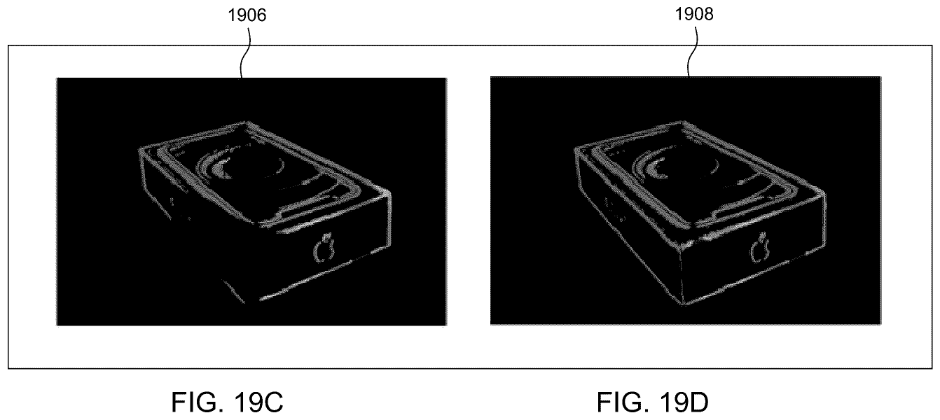

FIG. 19A illustrates one or more underexposed images of the at least one object with missing depth information, in accordance with an example embodiment of the present disclosure.

As described above, the at least one image capturing device 110 may be configured to capture the one or more images. In some embodiments, the at least one image capturing device 110 may capture one or more underexposed images. In some embodiments, an exemplary scenario may be depicted involving the one or more underexposed images, as illustrated by 1902. The one or more underexposed images may be the one or more images captured with insufficient exposure to light, resulting in a darker or dimly lit one or more images and showcasing the impact of underexposure on the quality of the one or more images. The one or more underexposed images may comprise missing the depth information. Further, the one or more underexposed images may comprise missing plurality of corners, and the plurality of edges.

The missing depth information may indicate that due to underexposure, the depth information of the at least one object 600 is not clearly visible or identifiable in the one or more captured images. Further, the missing depth information may indicate that the depth information associated with the plurality of edges of the at least one object 600 is not accurately represented due to the lack of sufficient lighting during capturing of the one or more images.

FIG. 19B illustrates properly formed edges from the plurality of edges and properly formed corners from the plurality of corners of the at least one object, in accordance with an example embodiment of the present disclosure.

In some embodiments, an exemplary scenario may be depicted involving properly formed edges and properly formed corners, as illustrated by 1904. In some embodiments, the properly formed edges may indicate that, after the calibration, the plurality of edges of the at least one object 600 are clearly and accurately defined in the one or more images. The calibration may refer to the adjustment or fine-tuning of the plurality of parameters of the at least one image capturing device 110. Further, the properly formed corners may indicate that the calibration process has successfully addressed the one or more underexposed images, in which the plurality of corners were either missing or poorly defined. The calibration may involve fine tuning the plurality of parameters that impact the detection and representation of the plurality of corners, leading to more accurate and well-defined plurality of corners in the one or more images.

FIG. 19C illustrates one or more underexposed images of another at least one object with missing depth information, in accordance with an example embodiment of the present disclosure.

In some embodiments, an exemplary scenario may be depicted involving the one or more underexposed images, as illustrated by 1906. The one or more underexposed images may be the one or more images captured with insufficient exposure to light, resulting in a darker or dimly lit one or more images and showcasing the impact of underexposure on the quality of the one or more images. The one or more underexposed images may comprise missing the depth information. Further, the one or more underexposed images may comprise missing plurality of corners, and the plurality of edges.

The missing depth information may indicate that due to underexposure, the depth information of the at least one object 600 is not clearly visible or identifiable in the one or more captured images. Further, the missing depth information may indicate that the depth information associated with the plurality of edges of the at least one object 600 is not accurately represented due to the lack of sufficient lighting during capturing of the one or more images.

FIG. 19D illustrates the one or more properly formed edges and the one or more properly formed corners of the another at least one object, in accordance with an example embodiment of the present disclosure.

In some embodiments, an exemplary scenario may be depicted involving properly formed edges and properly formed corners, as illustrated by 1908. In some embodiments, the properly formed edges may indicate that, after the calibration, the plurality of edges of the at least one object 600 are clearly and accurately defined in the one or more images. The calibration may refer to the adjustment or fine-tuning of the plurality of parameters of the at least one image capturing device 110. Further, the properly formed corners may indicate that the calibration process has successfully addressed the one or more underexposed images, in which the plurality of corners were either missing or poorly defined. The calibration may involve fine tuning the plurality of parameters that impact the detection and representation of the plurality of corners, leading to more accurate and well-defined plurality of corners in the one or more images.

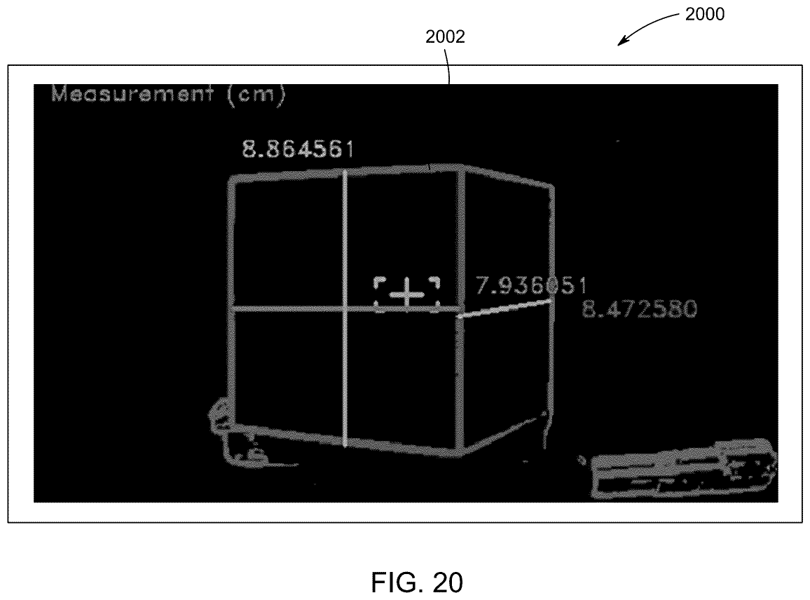

FIG. 20 illustrates a simulation result 2000 showing determination of the plurality of dimensions of at least one object 2002, in accordance with an example embodiment of the present disclosure.

The simulation result 2000 may provide information on each step of the simulation conducted using the system 100. In some embodiments, the simulation result 2000 may be depicted involving the use of the at least one object 2002. In some embodiments, the at least one object 2002 may correspond to a calibration cube with dimensions of 8 centimeters (cm) by 8 cm by 8 cm. The calibration cube may serve as the at least one object 2002 of known dimensions and properties. The 8*8*8 cm calibration cube may be employed to evaluate and calibrate the system 100. The simulation result 2000 may involve capturing the one or more images of the calibration cube using the at least one image capturing device 110, and the known dimensions of the calibration cube may allow for a comparison with measurements of the system 100. The simulation result may help validate the accuracy and reliability of the system 100, ensuring that the system 100 can provide precise spatial information for the at least one object 2002 in the real-world. The simulation result with the calibration cube may serve as a quality assurance and calibration procedure to enhance the performance of the system 100 in accurately determining the plurality of dimensions. In some embodiments, the plurality of dimensions of the calibration cube is determined as 8.864561 cm in height, 7.936051 cm in length, and 8.472580 cm in width.

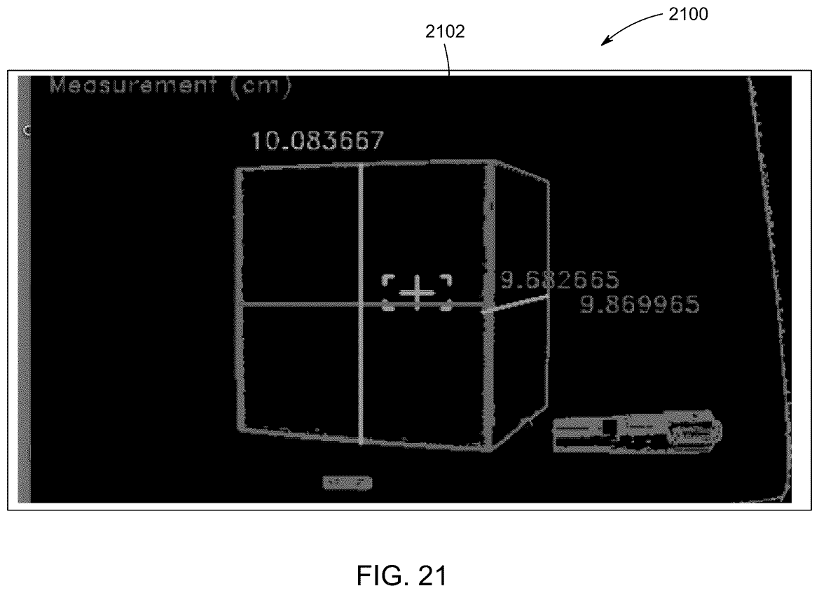

FIG. 21 illustrates another simulation result 2100 showing determination of a plurality of dimensions of at least one object 2102, in accordance with an example embodiment of the present disclosure.

The simulation result 2100 may provide information on each step of the simulation conducted using the system 100. In some embodiments, the simulation result 2100 may be depicted involving the use of the at least one object 2102. In some embodiments, the at least one object 2102 may correspond to a calibration cube with dimensions of 10 cm by 10 cm by 10 cm. The simulation result 2100 may involve capturing the one or more images of the calibration cube using the at least one image capturing device 110, and the known dimensions of the calibration cube may allow for a comparison with measurements of the system 100. The simulation result 2100 using the 10 cm*10 cm*10 cm calibration cube may indicate that the system 100 measured the plurality of dimensions as 10.083667 cm in height, 9.682665 cm in length, and 9.869965 cm in width.

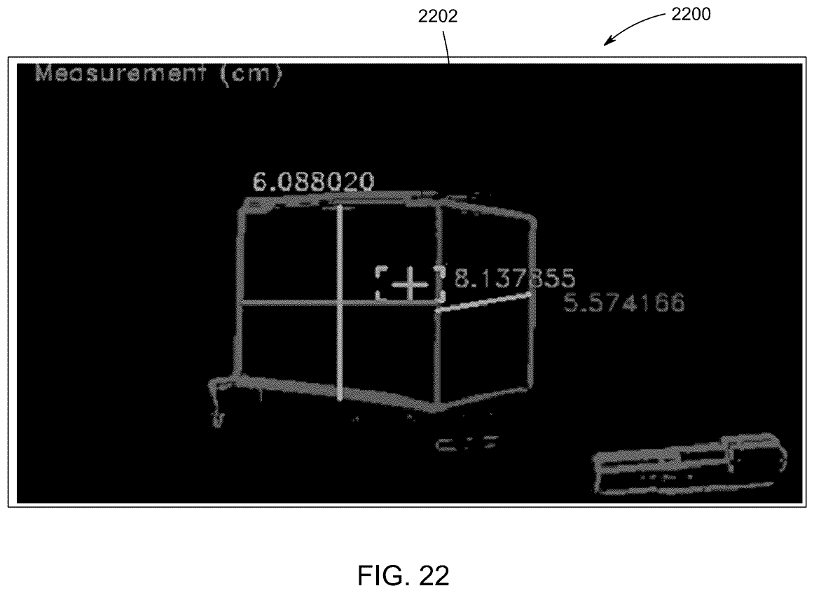

FIG. 22 illustrates another simulation result 2200 showing determination of a plurality of dimensions of at least one object 2202, in accordance with an example embodiment of the present disclosure.

The simulation result 2200 may provide information on each step of the simulation conducted using the system 100. In some embodiments, the simulation result 2200 may be depicted involving the use of the at least one object 2202. In some embodiments, the at least one object 2202 may correspond to a calibration cuboid with dimensions of 6 cm by 5 cm by 7.5 cm. The simulation result 2200 may involve capturing the one or more images of the calibration cuboid using the at least one image capturing device 110, and the known dimensions of the calibration cuboid may allow for a comparison with measurements of the system 100. The simulation result 2200 using the 6 cm*5 cm*7.5 cm calibration cube may indicate that the system 100 measured the plurality of dimensions as 6.088020 cm in height, 8.137855 cm in length, and 5.574166 cm in width.

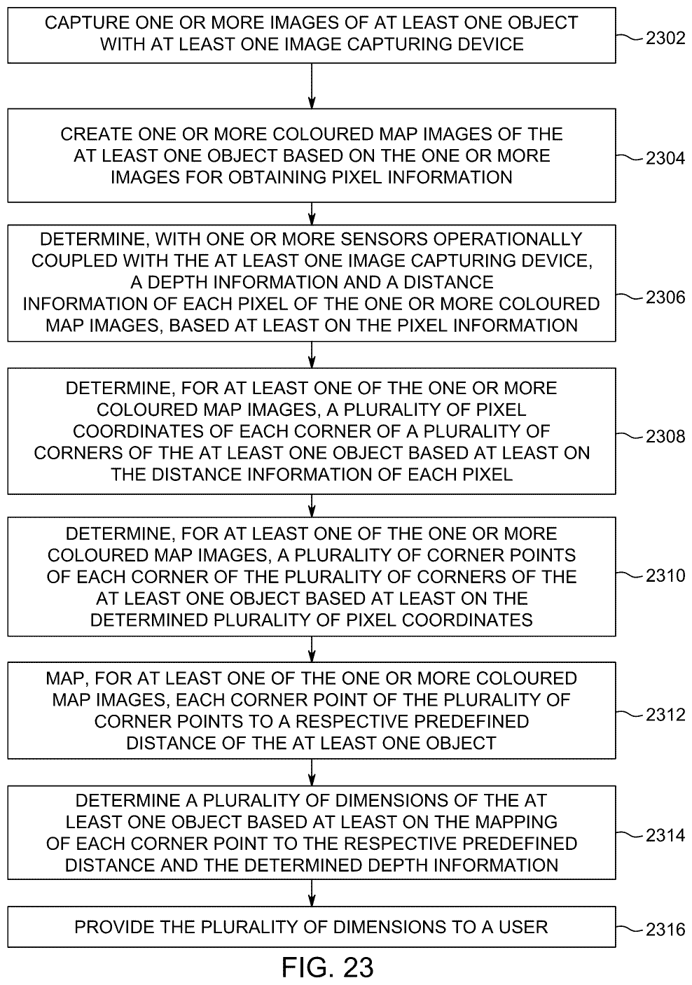

FIG. 23 illustrates a flowchart showing a method 2300 for the system for box dimensioning, in accordance with an example embodiment of the present disclosure.

At operation 2302, the at least one image capturing device 110 of the scanner 102 may be configured to capture one or more images of at least one object 600. In some embodiments, the tunable lens 1700 may be communicatively coupled to the at least one image capturing device 110. The tunable lens 1700 may be configured to fine-tune the plurality of parameters of the image capturing device. In some embodiments, the plurality of parameters may comprise at least one of exposure, analog gain, and/or confidence threshold and the plurality of corrective measures. Further, the plurality of corrective measures may comprise lightning conditions, background contrast, reduce reflection, and repositioning of the at least one image capturing device 110.

At operation 2304, the at least one image capturing device 110 may be configured to create one or more coloured map images of the at least one object 600 based on the one or more images for obtaining pixel information. In some embodiments, the one or more coloured map images may provide about visual characteristics of the at least one object 600. The pixel information may then be further utilized for various purposes, such as image segmentation, analysis, or the measurement of the plurality of dimensions. In some embodiments, the at least one system processor 104 may be configured to convert the one or more coloured map images into one or more grey scale images. The one or more grey scale images may be configured to decode one or more values of the one or more one-dimensional barcodes and the one or more two-dimensional barcodes of the at least one object 600 in the one or more grey scale images. Further, the at least one system processor 104 may be configured to aggregate the one or more vales decoded of the one or more one-dimensional barcodes and the one or more two-dimensional barcodes and the plurality of dimensions of the at least one object 600, for displaying on a display device of a user.

At operation 2306, the one or more sensors 114 operationally coupled with the at least one image capturing device 110, may be configured to determine the depth information and the distance information of each pixel of the one or more coloured map images, based at least on the pixel information. At operation 2308, the at least one system processor 104 may be configured to determine, for at least one of the one or more coloured map images, the plurality of pixel coordinates of each corner of the plurality of corners of the at least one object 600 based at least on the distance information of each pixel. In some embodiments, the at least one system processor 104 may be configured to determine the plurality of corners by using the depth information received from the one or more sensors 114 or using deep learning protocols.

At operation 2310, the at least one system processor 104 may be configured to determine, for at least one of the one or more coloured map images, the plurality of corner points of each corner of the plurality of corners of the at least one object 600 based at least on the determined plurality of pixel coordinates. In some embodiments, the plurality of corner points may comprise at least one of length coordinates, breadth coordinates, and height coordinates. In some embodiments, the at least one system processor 104 may be configured to map the determined plurality of corner points to the respective predefined distance of the at least one object 600 using the sparse depth map.

At operation 2312, the at least one system processor 104 may be configured to map, for at least one of the one or more coloured map images, each corner point of the plurality of corner points to the respective predefined distance of the at least one object 600. In some embodiments, the at least one system processor 104 may be configured to map the determined plurality of corner points to the respective predefined distance of the at least one object 600 using the sparse depth map. At operation 2314, the at least one system processor 104 may be configured to determine the plurality of dimensions of the at least one object 600 based at least on the mapping of each corner point and the determined depth information. Thereafter, at operation 2316, the at least one system processor 104 may be configured to provide the plurality of dimensions to the at least one user device.

In some embodiments, the method 2300 may further comprise masking, via the at least one system processor 104, the one or more coloured map images. The method 2300 may further comprise determining, via the at least one system processor 104, the distance of each pixel from a focal plane based at least on the masked one or more images.

The present disclosure efficiently performs tasks that typically require separate devices, by integrating a scanner equipped with at least one image capturing device and one or more sensors. In some embodiments, the utilization of the captured one or more images for both 2D barcode decoding and 3D dimensioning may streamline processes and reduces the need for additional equipment, thereby enhancing convenience and cost-effectiveness. Further, the 3D dimensioning functionality, facilitated by the one or more sensors, may enable precise measurements of at least one object dimensions in terms of length, breadth, and height. In some embodiments, accurate measurements may be determined smoothly through the system and the method, by optimally calculating the plurality of corners and maps the plurality of corners to real-world distance. Further, the incorporation of the tunable lens system to calibrate the at least one image capturing device, may refine accuracy, to ensure reliable results. Moreover, by seamlessly integrating barcode decoding with 3D dimensioning, the system may provide comprehensive information about the scanned at least one object, to enhance workflow efficiency. The system's versatility in seamlessly transitioning between 2D imaging, 3D dimensioning, and 3D modelling positions the as a powerful and adaptable tool for applications ranging from logistics to manufacturing, where accurate spatial information is paramount. The integration of 5D technology in the scanner may represent a significant advancement in capturing holistic data for a wide array of objects in real-world scenarios. Overall, the present disclosure may aid in data collection and measurement processes and offers unparalleled versatility and accuracy in a single system.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprises a scanner configured to:
capture one or more images of at least one object with at least one image capturing device; and,
create one or more coloured map images of the at least one object based on the one or more images for obtaining pixel information;
wherein one or more sensors are operationally coupled with the at least one image capturing device and configured to determine a depth information and a distance information of each pixel of the one or more coloured map images, based at least on the pixel information; at least one system processor operationally coupled with the scanner and at least one memory storing instructions that when executed by the at least one system processor causes the system to:
determine, for at least one of the one or more coloured map images, a plurality of pixel coordinates of each corner of a plurality of corners of the at least one object based at least on the distance information of each pixel;
determine, for at least one of the one or more coloured map images, a plurality of corner points of each corner of the plurality of corners of the at least one object based at least on the plurality of pixel coordinates;
map, for at least one of the one or more coloured map images, each corner point of the plurality of corner points to a respective predefined distance of the at least one object; and,
determine a plurality of dimensions of the at least one object based at least on the mapping of each corner point to the respective predefined distance and the determined depth information.

2. The system of claim 1, wherein the at least one system processor is further configured to:
mask the one or more coloured map images; and,
determine the distance information of each pixel from a focal plane based at least on the masked one or more coloured images.

3. The system of claim 1, wherein the at least one memory storing instructions, when executed by the at least one system processor, further cause the system to map the determined plurality of corner points to the respective predefined distance of the at least one object using a sparse depth map, and wherein the plurality of corner points comprise at least one of length coordinates, breadth coordinates, and height coordinates.

4. The system of claim 1, wherein the at least one memory storing instructions, when executed by the at least one system processor, further cause the system to:
convert the one or more coloured map images into one or more grey scale images; and,
decode one or more values of one or more one-dimensional barcodes or one or more two-dimensional barcodes associated with the at least one object based on the one or more grey scale images.

5. The system of claim 4, wherein the at least one memory storing instructions, when executed by the at least one system processor, further cause the system to:
aggregate the one or more values decoded of the one or more one-dimensional barcodes and the one or more two-dimensional barcodes and the plurality of dimensions of the at least one object; and,
display the one or more values aggregated on a display device.

6. The system of claim 1, wherein the at least one memory storing instructions, when executed by the at least one system processor, further cause the system to:
determine the plurality of corners by using the depth information received from the one or more sensors or using deep learning protocols, wherein the deep learning protocols correspond to a convolutional neural network (CNN) based corner detection technique that takes the one or more coloured map images as an input and outputs a region that corresponds to the plurality of corners.

7. The system of claim 1, wherein the at least one memory storing instructions, when executed by the at least one system processor, further cause the system to:
perform image segmentation on the one or more images to determine a plurality of edges from the plurality of corners.

8. The system of claim 7, wherein the image segmentation is performed by:
drawing a plurality of imaginary lines over the one or more images to connect each corner of the plurality of corners;
discarding one or more intersecting imaginary lines from the plurality of imaginary lines; and,
connecting the plurality of corners in an anticlockwise direction or in a clockwise direction to determine the plurality of edges.

9. The system of claim 1, wherein the one or more sensors comprise at least a CMOS sensor, and wherein the CMOS sensor comprises at least one integrated circuit configured to determine the depth information by using object dimensioning of a three-dimensional image.

10. The system of claim 1, wherein a tunable lens is communicatively coupled to the at least one image capturing device, the tunable lens configured to fine-tune a plurality of parameters of the image capturing device, wherein the plurality of parameters comprises at least one of exposure, analog gain, and/or confidence threshold and a plurality of corrective measures, wherein the plurality of corrective measures comprises lightning conditions, background contrast, reduce reflection, and repositioning of the at least one image capturing device.

11. A method comprising:
capturing one or more images of at least one object with at least one image capturing device of a scanner;
creating one or more coloured map images of the at least one object based on the one or more images for obtaining pixel information;
determining, with one or more sensors operationally coupled with the at least one image capturing device, a depth information and a distance information of each pixel of the one or more coloured map images, based at least on the pixel information;
determining, for at least one of the one or more coloured map images, a plurality of pixel coordinates of each corner of a plurality of corners of the at least one object based at least on the distance information of each pixel;
determining, for at least one of the one or more coloured map images, a plurality of corner points of each corner of the plurality of corners of the at least one object based at least on the plurality of pixel coordinates;
mapping, for at least one of the one or more coloured map images, each corner point of the plurality of corner points to a respective predefined distance of the at least one object; and,
determining a plurality of dimensions of the at least one object based at least on the mapping of each corner point to the respective predefined distance and the determined depth information.

12. The method of claim 11 further comprising:
masking the one or more coloured map images; and,
determining the distance information of each pixel from a focal plane based at least on the masked one or more images.

13. The method of claim 11, further comprising mapping the determined plurality of corner points to the respective predefined distance of the at least one object using a sparse depth map, and wherein the plurality of corner points comprises at least one of length coordinates, breadth coordinates, and height coordinates.

14. The method of claim 11 further comprising:
converting the one or more coloured map images into one or more grey scale images; and,
decoding one or more values of one or more one-dimensional barcodes or one or more two-dimensional barcodes associated with the at least one object based on the one or more grey scale images.

15. The method of claim 14 further comprising:
aggregating the one or more values decoded of the one or more one-dimensional barcodes and the one or more two-dimensional barcodes and the plurality of dimensions of the at least one object; and,
displaying the one or more values aggregated on a display device.

16. The method of claim 11 further comprising determining the plurality of corners by using the depth information received from the one or more sensors or using deep learning protocols, wherein the deep learning protocols correspond to a convolutional neural network (CNN) based corner detection technique that takes the one or more coloured map images as an input and outputs a region that corresponds to the plurality of corners.

17. The method of claim 11, further comprising performing image segmentation on the one or more images to determine a plurality of edges from the plurality of corners.

18. The method of claim 17, wherein the image segmentation is performed by:
drawing a plurality of imaginary lines over the one or more images to connect each corner of the plurality of corners;
discarding one or more intersecting imaginary lines from the plurality of imaginary lines; and,
connecting the plurality of corners in an anticlockwise direction or in a clockwise direction to determine the plurality of edges.

19. The method of claim 11, wherein the one or more sensors comprise at least a CMOS sensor, and wherein the CMOS sensor comprises at least one integrated circuit configured to determine the depth information by using object dimensioning of a three-dimensional image.

20. The method of claim 11, further comprising a tunable lens communicatively coupled to the at least one image capturing device, the tunable lens is configured to fine-tune a plurality of parameters of the image capturing device, wherein the plurality of parameters comprises at least one of exposure, analog gain, and/or confidence threshold and a plurality of corrective measures, wherein the plurality of corrective measures comprises lightning conditions, background contrast, reduce reflection, and repositioning of the at least one image capturing device.
